(19) United States
(12) Patent Application Publication
(10) Pub. No.: US 2006/0245658 A1
(43) Pub. Date: Nov. 2, 2006

(54) Coding device, decoding device, coding method, decoding method, and storage medium storing program for execution of those

(75) Inventors: Tomoki Taniguchi, Nakai-machi (JP); Taro Yokose, Nakai-machi (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/297,331

(22) Filed: Dec. 9, 2005

(30) Foreign Application Priority Data
Apr. 27, 2005 (JP) 2005-129440

(51) Int. Cl. G06K 9/36; G06K 9/46

(52) U.S. Cl. 382/246

(57) ABSTRACT

A coding device includes a first coding unit that uses a Markov model coding system to code noticed data as a coding object, a second coding unit that uses a coding system different from the Markov model coding system to code the noticed data, and a selection unit that selects, as a coding unit to be applied, one of the first coding unit and the second coding unit based on the noticed data.

### CROSS-REFERENCE TO RELATED APPLICATION

This application claims priority under 35 USC 119 from Japanese Patent Application No. 2005-129440, the disclosure of which is incorporated by reference herein.

### BACKGROUND OF THE INVENTION

(1) Field of the Invention

The present invention relates to a coding device which switches a code according to a context, a decoding device, a coding method, a decoding method, and a storage medium storing a program for execution of those.

(2) Description of the Related Art

For example, patent document 1 (JP-A-8-298599) discloses an image coding method in which density differences between a specific pixel “a” near a noticed pixel “x” and peripheral pixels “b” and “c” of the noticed pixel “x” are calculated, and when either one of the calculated density differences is a specified value or less, Markov model coding is performed for the calculated density difference, and when both of the calculated density differences are the specified value or more, predictive coding is performed for the noticed pixel “x”.

### SUMMARY OF THE INVENTION

The present invention has been made in view of the above circumstances and provides a coding device which codes data at a relatively low process load.

According to an aspect of the invention, a coding device includes a first coding unit that uses a Markov model coding system to code noticed data as a coding object, a second coding unit that uses a coding system different from the Markov model coding system to code the noticed data, and a selection unit that selects, as a coding unit to be applied, one of the first coding unit and the second coding unit based on the noticed data.

### BRIEF DESCRIPTION OF THE DRAWINGS

Embodiments of the invention will be described in detail based on the following figures, wherein:

FIG. 1 is a view exemplifying a structure of a coding program 9 to realize a JPEG-LS system coding process;

FIG. 2 is a flowchart of a coding process (S90) by the coding program 9 (FIG. 1);

FIGS. 3A and 3B are views for explaining a determination process of a context;

FIG. 4 is a view exemplifying a structure of a coding program 5 in a first embodiment;

FIG. 5A is a view for explaining a run-length generation part 510 in more detail;

FIG. 5B is a view for explaining a prediction error generation part 540 in more detail;

FIG. 6 is a flowchart of a first coding process (S10) performed by the coding program 5;

FIG. 7 is a flowchart for explaining in more detail a prediction error generation process (S120) explained in FIG. 6;

FIG. 8 is a flowchart for explaining in more detail a code parameter generation process (S140) explained in FIG. 6;

FIG. 9A is a view exemplifying code identification information;

FIG. 9B is a view exemplifying code data;

FIG. 10 is a view exemplifying a structure of a decoding program 6 in the first embodiment;

FIG. 11 is a flowchart of a first decoding process (S20) performed by the decoding program 6;

FIG. 12A is a graph showing bit rates of image data coded by the first coding program 5 and bit rates of image data coded by a coding program 9 based on a Markov model;

FIG. 12B is a graph showing coding process speeds of the first coding program 5 and coding process speeds of the coding program 9 based on the Markov model;

FIG. 13 is a graph showing a relation between a context Q relating to a CG image and a code parameter;

FIG. 14 is a graph showing a relation between a context Q relating to a natural image and a code parameter;

FIG. 15 is a view exemplifying a structure of a second Markov model coding part;

FIG. 16 is a view exemplifying a code parameter stored in a parameter storage part 590;

FIG. 17 is a flowchart for explaining a second code parameter generation process (S340);

FIG. 18 is a view exemplifying a structure of a second Markov model decoding part;

FIG. 19 is a view for explaining a modified example of a prediction process by a prediction part of the Markov model coding part or the Markov model decoding part;

FIG. 20 is a flowchart of a modified example (S740) of a code parameter generation process; and

FIG. 21 is a view exemplifying a hardware structure of an image processing apparatus 2 to which a coding method and a decoding method of the invention are applied, while importance is attached to a control device 21.

### DETAILED DESCRIPTION OF THE INVENTION

First, for facilitating the understanding of the invention, its background and outline will be described.

In recent years, with the spread of digital cameras, chances to deal with digital images are increased, and a request for improvement in the quality of digital images has been raised. Thus, a request for a reversible coding method, which is an image coding method having no degradation in picture quality, has been raised.

As the reversible coding method as stated above, Markov model coding is known.

In the Markov model coding system, with respect to noticed data (for example, a noticed pixel) as a coding object, a judgment is made as to a state (that is, context) of reference data located around the noticed data (for example, pixel values of pixels located around the noticed pixel), and a coding process corresponding to the judged state (context) is applied.

Hereinafter, as a specific example of the Markov model coding system, a JPEG-LS system will be described.

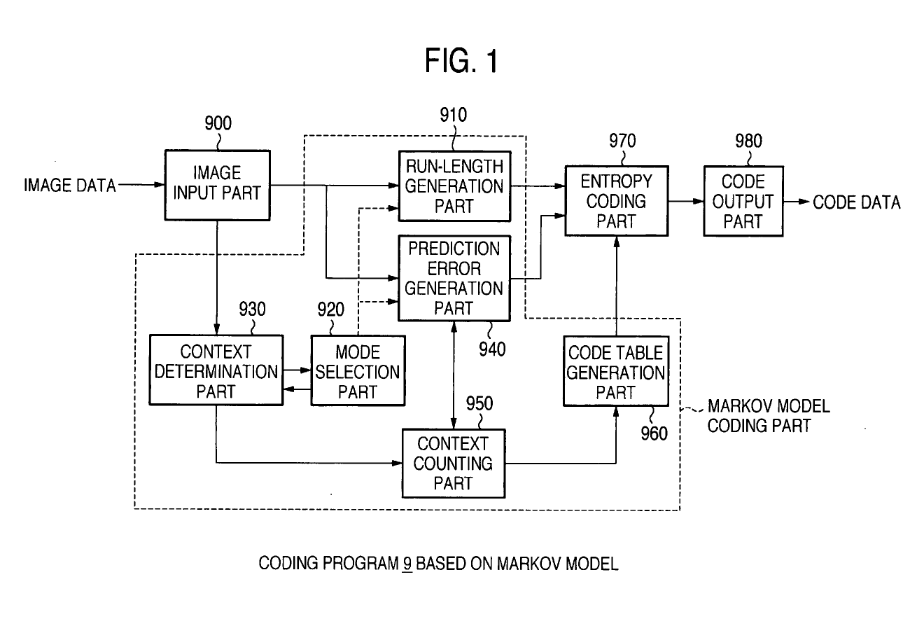

FIG. 1 is a view exemplifying a structure of a coding program 9 to realize the coding process of the JPEG-LS system.

As exemplified in FIG. 1, the coding program 9 is a program to perform the coding process based on the Markov model coding system, and includes an image input part 900, a run-length generation part 910, a mode selection part 920, a context determination part 930, a prediction error generation part 940, a context counting part 950, a code table generation part 960, an entropy coding part 970, and a code output part 980.

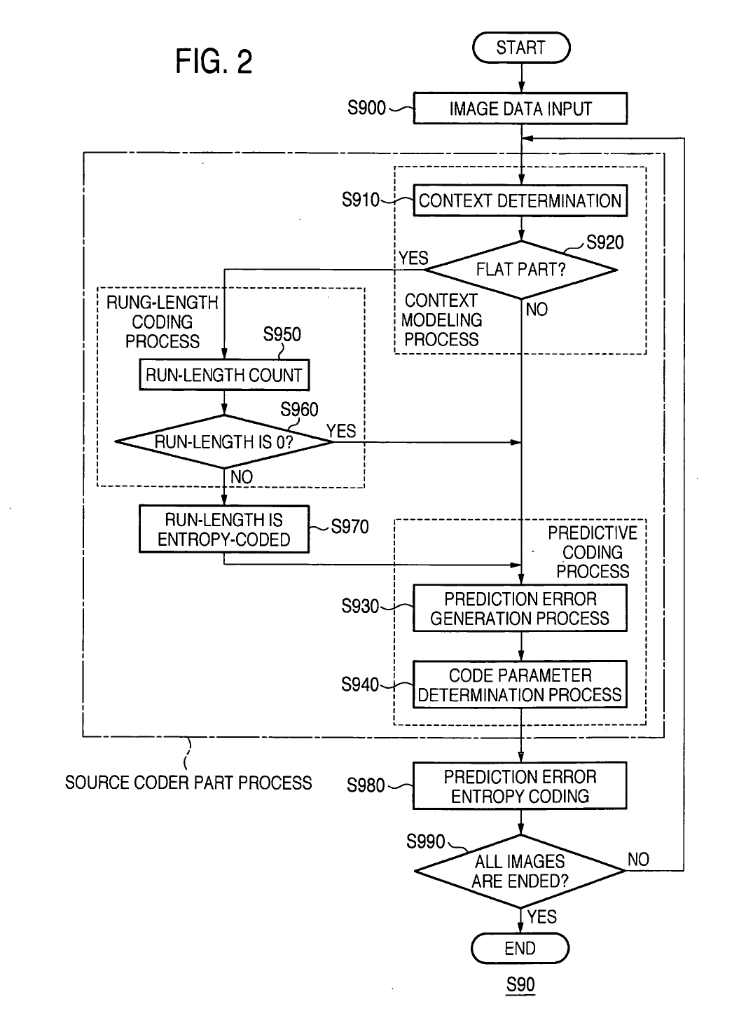

FIG. 2 is a flowchart of a coding process (S90) by the coding program 9 (FIG. 1). Incidentally, in this example, although a description will be given to, as a specific example, a case in which image data is a coding object, the invention is not limited to this. The coding object may be, for example, sound data.

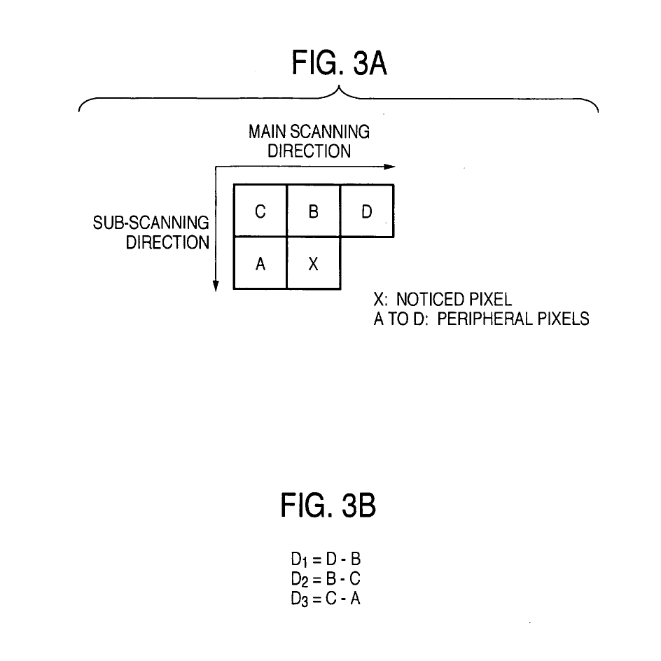

FIGS. 3A and 3B are views for explaining a determination process of a context.

As shown in FIG. 2, at step 900 (S900), the image input part 900 (FIG. 1) sets a noticed pixel X (FIG. 3) as a process object in scan order from image data as a coding object, and outputs a pixel value of the noticed pixel X to the run-length generation part 910, the prediction error generation part 940, and the context determination part 930.

At step 910 (S910), the context determination part 930 holds the pixel values of the noticed pixel inputted from the image input part 900 up to a fixed number, and determines the context of the noticed pixel X based on the held pixel value.

Specifically, as exemplified in FIG. 3A, the context determination part 930 reads pixel values of plural peripheral pixels A to D corresponding to the noticed pixel X, and calculates a first difference value D₁, a second difference value D₂ and a third difference value D₃ shown in FIG. 3B by using the read pixel values of the peripheral pixels A to D. The first difference value D₁ is the value obtained by subtracting the pixel value of the peripheral pixel B from the pixel value of the peripheral pixel D, the second difference value D₂ is the value obtained by subtracting the pixel value of the peripheral pixel C from the pixel value of the peripheral pixel B, and the third difference value D₃ is the value obtained by subtracting the pixel value of the peripheral pixel A from the pixel value of the peripheral pixel C.

The context determination part 930 outputs the calculated first difference value D₁, the second difference value D₂ and the third difference value D₃ to the mode selection part 920.

At step 920 (S920), based on the first difference value D₁, the second difference value D₂ and the third difference value D₃ inputted from the context determination part 930, the mode selection part 920 judges whether a flat part exists. Specifically, in the case where all of the first difference value D₁, the second difference value D₂ and the third difference value D₃ inputted from the context determination part 930 are 0, the mode selection part 920 judges that the flat part exists, and instructs the run-length generation part 910 to apply a run-length coding system. In the other cases, the mode selection part judges that the flat part does not exist, and instructs the prediction error generation part 940 and the context determination part 930 to apply a predictive coding system.

Here, the run-length coding system is the system of coding the number which is the number of noticed data (in this example, the pixel value of the noticed pixel) and reference data (in this example, the pixel values of the peripheral pixels) continuously consistent with each other, and at least one piece of reference data is set for the respective noticed data. That is, the run-length coding system of the invention includes not only the system in which the continuous consistent number of the noticed data and the adjacent reference data (in this example, the pixel value of the peripheral pixel A) is coded, but also the system in which the continuous consistent number of the noticed data and reference data (for example, the pixel value of the peripheral pixel B and the pixel value of the peripheral pixel C) located at other relative positions in regard to the noticed data is coded.

Besides, the predictive coding system is the system in which a prediction value of noticed data (in this example, the noticed pixel) is generated from reference data (in this example, the pixel value of the peripheral pixel) for each noticed pixel, a difference between the generated prediction value and the noticed data is calculated, and the calculated prediction error is coded.

In the coding program 9, in the case where it is judged by the mode selection part 920 that the flat part exists, a shift is made to a process of S950, and in the case where it is judged by the mode selection part 920 that the flat part does not exist, a shift is made to a process of S930.

At step 930 (S930), in accordance with the instruction from the mode selection part 920, the context determination part 920 calculates a context value Q based on the calculated first difference value D₁, the second difference value D₂, and the third difference value D₃, and outputs the calculated context value Q to the context counting part 950.

The context counting part 950 calculates the inputted context value Q by a specified method under the condition that the context value Q inputted from the context determination part 920 is inputted.

The prediction error generation part 940 generates the prediction value of the noticed pixel X in accordance with the instruction from the mode selection part 920, calculates the difference between the generated prediction value and the pixel value of the noticed pixel X, and outputs the calculated difference as the prediction error to the entropy coding part 970 and the context counting part 950. Incidentally, the prediction error inputted to the context counting part 950 is used for the correction of the prediction value generated by the prediction error generation part 940.

At step 940 (S940), the code table generation part 960 determines a code parameter based on the context value Q counted by the context counting part 950, and outputs the determined code parameter to the entropy coding part 970. The code parameter is the parameter to determine a code group, and is, for example, the parameter to generate a Golomb code.

At step 950 (S950), the run-length generation part 910 holds the pixel values inputted from the image input part 900 up to a fixed number, and uses the held pixel values to generate the prediction value of the noticed pixel X.

The run-length generation part 910 compares the pixel value of the noticed pixel X with the prediction value of the noticed pixel X while updating the noticed pixel X in the scan direction, and counts the continuous consistent number.

At step 960 (S960), the run-length generation part 910 judges whether the counted continuous consistent number is 0 or not when the pixel value of the noticed pixel X and the prediction value are not consistent with each other (that is, the run is interrupted), and in the case where the continuous consistent number is 0, a shift is made to the process of S930, and in the case where the continuous consistent number is 1 or more, the counted continuous consistent number is outputted to the entropy coding part 970, and a shift is made to a process of S970.

At step 970 (S970), the entropy coding part 970 uses a fixed code table to entropy-code the continuous consistent number inputted from the run-length generation part 910, and outputs the code to the code output part 980.

At step 980 (S980), the entropy coding part 970 entropy-codes the prediction error inputted from the prediction error generation part 940, and outputs the code to the code output part 980.

More specifically, the entropy coding part 970 uses the code parameter inputted from the code table generation part 960 to code the inputted prediction error.

At step 990 (S990), the coding program 9 judges whether all the pixels included in the pixel data are coded or not, and in the case where all the pixels are coded, the coding process (S90) is ended, and in the case where there are pixels not coded, a next pixel in the scanning order is set to the noticed pixel X, and a return is made to the process of S910.

As stated above, as shown in FIG. 2, the coding program 9 determines the context (in this example, the difference values D) indicating the change state of the peripheral pixels from the peripheral pixels A to D around the noticed pixel X (S910), and switches between the run-length coding process (S950 to S970) and the predictive coding process (S930 and S940) based on the Markov model coding system in accordance with the determined context.

Besides, in the image coding method disclosed in patent document 1, the density differences between the specific pixel near the noticed pixel and the peripheral pixels of the noticed pixel are calculated, and when any one of the calculated density differences is the specified value or less, the Markov model coding is performed for the calculated density difference, and when all of the calculated density differences are the specified value or more, predictive coding is performed for the noticed pixel.

That is, in any of the coding methods, reference is made to the other pixel group different from the noticed pixel, the change degree of the pixel values of the other pixel group is evaluated, and the coding system is switched in accordance with the evaluation result (specifically the difference of the pixel values). As stated above, since the coding process is designed based on the Markov model coding, the change degree of the pixel value is evaluated with respect to the other pixel group and the coding system is switched.

On the other hand, the coding program 5 (described later) of this embodiment performs the coding process based on the predictive coding system. That is, the coding program 5 switches the coding system based on the pixel value of the noticed pixel X. More specifically, the coding program 5 compares the noticed pixel X with the peripheral pixel, and applies the run-length coding system or the Markov model coding system in accordance with the comparison result.

Especially, the coding program 5 of this example applies the run-length coding system using plural prediction parts, and compares the peripheral pixels corresponding to these prediction parts with the noticed pixel, and selects the run-length coding system or the Markov model coding system, and accordingly, the possibility that the run-length coding system is selected becomes higher.

Besides, the process of judging whether or not the noticed pixel and the peripheral pixel are consistent with each other is simpler than the process in which the three difference values D are calculated and it is judged whether all of the three calculated difference values D are 0 or not, and the process load is low.

### First Embodiment

First, the coding program 5 in a first embodiment and the operation of the coding program 5 will be described.

[Coding Program]

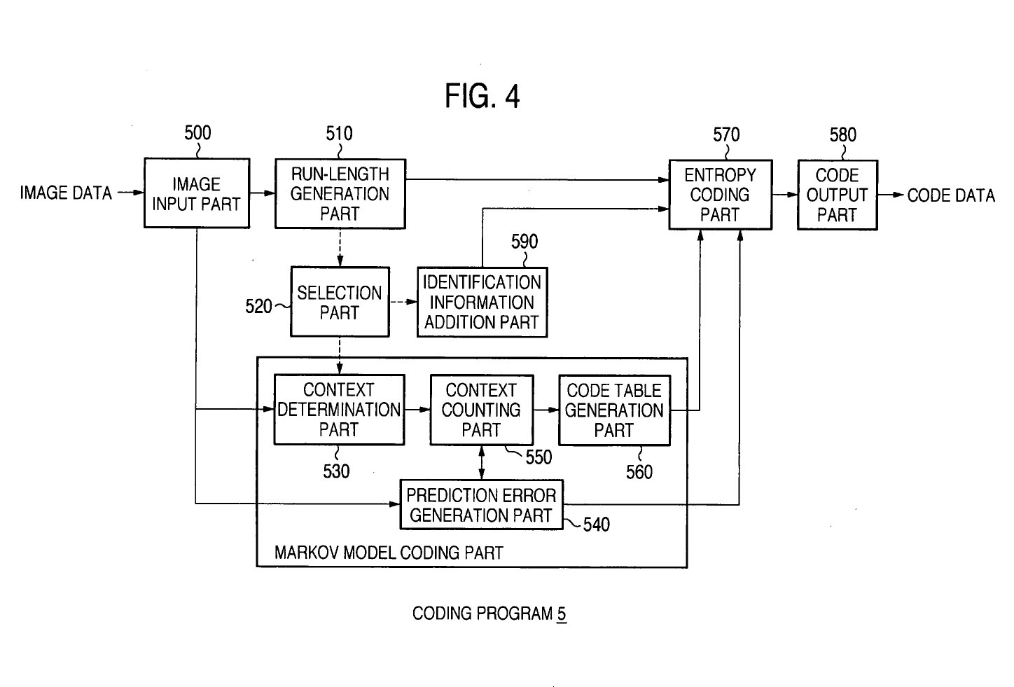

FIG. 4 is a view exemplifying a structure of the coding program 5 of the first embodiment.

As exemplified in FIG. 4, the first coding program 5 includes an image input part 500, a run-length generation part 510, a selection part 520, a context determination part 530, a prediction error generation part 540, a context counting part 550, a code table generation part 560, an entropy coding part 570, a code output part 580, and an identification information addition part 590.

The coding program 5 is installed in an image processing apparatus 2 and realizes the coding process.

Incidentally, the context determination part 530, the prediction error generation part 540, the context counting part 550, and the code table generation part 560 (hereinafter, these are collectively referred to as a Markov model coding part) realize the main part of the Markov model coding process, and the run-length generation part 510 realizes the main part of the coding process of the run-length coding system. Incidentally, the pair of the Markov model coding part and the entropy coding part 570 is an example of a first coding unit of the invention, and the pair of the run-length generation part 510 and the entropy coding part 570 is an example of a second coding unit of the invention.

In the coding program 5, the image input part 500 acquires image data as a coding object, and outputs partial data as a process object in the acquired image data to the run-length generation part 510, the context determination part 530 and the prediction error generation part 540 in sequence.

The image input part 500 of this example outputs a pixel value at every pixel constituting the image to the context determination part 522, the prediction error calculation part 542 and the prediction part 544.

The run-length generation part 510 compares the pixel value of the noticed pixel with the pixel value of a peripheral pixel located at a fixed position with respect to the noticed pixel, calculates the number of these pixel values continuously consistent with each other (that is, the continuous consistent number), and outputs the calculated continuous consistent number to the entropy coding part 570.

The run-length generation part 510 of this example compares the pixel value of the noticed pixel with the pixel values of the plural peripheral pixels, calculates the continuous consistent number with respect to the plural peripheral pixels, determines the most suitable continuous consistent number (hereinafter referred to as the optimum continuous consistent number) based on the calculated continuous consistent number, and outputs the determined optimum continuous consistent number and identification information (hereinafter referred to as prediction part ID) to identify the peripheral pixel corresponding to the optimum continuous consistent number to the entropy coding part 570. Incidentally, the optimum continuous consistent number of this example and the identification information corresponding thereto are an example of consistent information of the invention.

Besides, the run-length generation part 510 outputs the comparison result between the pixel value of the noticed pixel and the pixel value of the peripheral pixel located at the fixed position with respect to the noticed pixel to the selection part 520.

The run-length generation part 510 of this example outputs information as to whether the pixel value of any one of the peripheral pixels is consistent with the pixel value of the noticed pixel to the selection part 520.

The selection part 520 (selection unit) selects the run-length coding system or the Markov model coding system based on the comparison result by the run-length generation part 510. More specifically, in the case where the pixel value of the noticed pixel and the pixel value of the peripheral pixel are consistent with each other, the selection part 520 controls the other components of the coding program 5 so as to code the run number generated by the run-length generation part 510, and in the case where the pixel value of the noticed pixel is not consistent with any of the pixel values of the peripheral pixels, the selection part controls the other components of the coding program 5 so as to perform the coding process by the Markov model coding part. That is, under the condition that the pixel value of the noticed pixel is not consistent with any of the pixel values of the peripheral pixels, the selection part 520 instructs the Markov model coding part to perform the determination process of the context, the generation process of the prediction error, and the determination process of the code parameter.

Besides, the selection part 520 notifies the identification information addition part 590 which coding system is selected. The selection part 520 of this example outputs that the pixel value of the noticed pixel is consistent with any one of the pixel values of the peripheral pixels (that is, the prediction is correct), or that the pixel value of the noticed pixel is not consistent with any of the pixel values of the peripheral pixels (that is, the prediction is not correct) to the identification information addition part 590.

With respect to each noticed pixel, based on the pixel values of the peripheral pixels located around the noticed pixel, the context determination part 530 (context judgment unit) calculates the context value indicating the change state of the pixel values, and outputs the calculated context value of each noticed pixel to the context counting part 550.

The prediction error generation part 540 calculates a difference between the image data inputted from the image input part 500 and the prediction value of the image data, and outputs the calculated difference as the prediction error to the entropy coding part 570.

The prediction error generation part 540 of this example uses the pixel value of the peripheral pixel located at a fixed position with respect to the noticed pixel to calculate a temporary prediction value, corrects the calculated prediction value based on the count value of the prediction error inputted from the context counting part 550, and outputs a difference between the corrected prediction value and the pixel value of the noticed pixel as the prediction error to the entropy coding part 570.

The context counting part 550 counts the context value inputted from the context determination part 530 and the prediction error value inputted from the prediction error generation part 540, and outputs the count result to the code table generation part 560 and the prediction error generation part 540.

The code table generation part 560 (code group selection unit) generates a code table based on the count result inputted from the context count part 550, and outputs the generated code table to the entropy coding part 570. The code table causes the data value (modeled input data) to correspond to the bit string (that is, code) assigned to the data value, and may be, for example, a table, or a parameter (hereinafter referred to as a code parameter) to calculate a code corresponding to a data value.

The code table generation part 560 of this example determines the code parameter to generate the Golomb code based on the count result of the context value and the count result of the prediction error.

The entropy coding part 570 entropy-codes the data value (run number or the like) inputted from the run-length generation part 510 or the prediction error value inputted from the prediction error generation part 540.

More specifically, in the case where the data value is inputted from the run-length generation part 510, the entropy coding part 570 uses the fixed code table to convert the inputted data value into the code. Besides, in the case where the prediction error is inputted from the prediction error generation part 540, the entropy coding part 570 uses the code table (in this example, the code parameter) generated by the code table generation part 560 to convert the inputted prediction error into the code.

The entropy coding part 570 of this example generates the Huffman code based on the data value inputted from the run-length generation part 510, and generates the Golomb code based on the prediction error inputted from the prediction error generation part 540 and the code parameter inputted from the code table generation part 560.

Besides, the entropy coding part 570 codes the code identification information inputted from the identification information addition part 590, causes the coded code identification information to correspond to the code of the data value inputted from the run-length generation part 510 or the code of the prediction error inputted from the prediction error generation part 540, and outputs it to the code output part 580.

The code output part 580 outputs the code generated by the entropy coding part 570 to the outside.

For example, the code output part 580 assembles the codes of the respective pixels inputted from the entropy coding part 570 into code data, and outputs the code data to a communication device 22 (described later), a recording device 24 (described later), or a printer device 3 (described later).

The identification information addition part 590 (identification information adding unit) adds code identification information to identify the applied coding system to the code in accordance with the selection result by the selection part 520.

The identification information addition part 590 of this example generates, as code identification information, information indicating whether or not the pixel value of the noticed pixel and the prediction value (pixel value of the peripheral pixel) are consistent with each other, and outputs the generated code identification information to the entropy coding part 570.

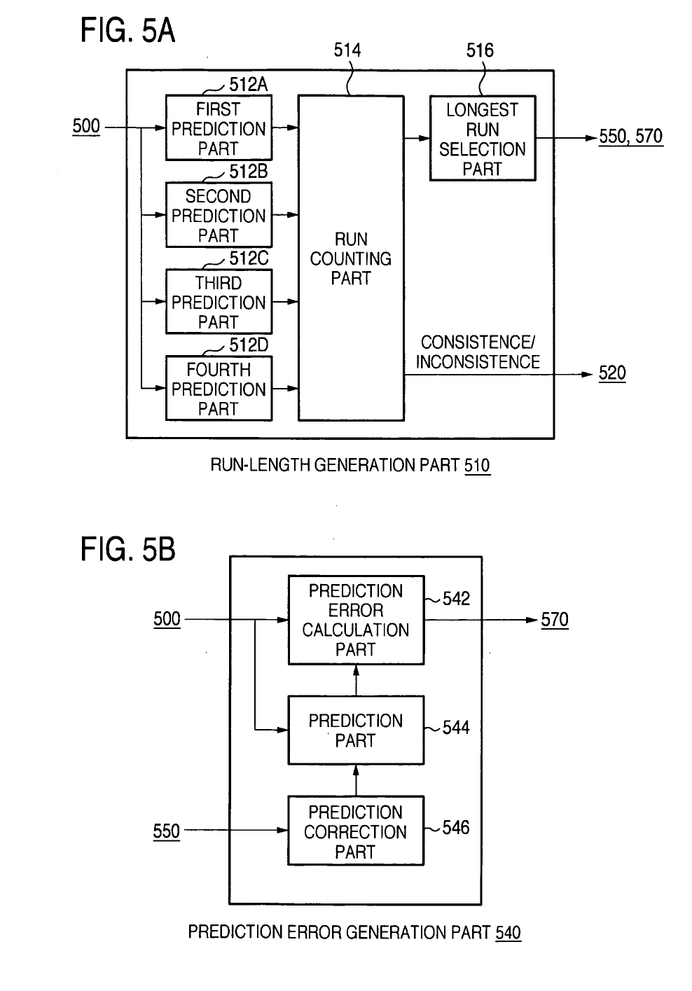

FIG. 5A is a view for explaining the run-length generation part 510 in more detail, and FIG. 5B is a view for explaining the prediction error generation part 540 in more detail.

As exemplified in FIG. 5A, the run-length generation part 510 includes plural prediction parts 512 (that is, a first prediction part to a fourth prediction part), a run counting part 514, and a longest run selection part 516.

In the run-length generation part 510, the plural prediction parts 512 generate prediction values of a noticed pixel by different prediction methods, and output, as prediction results, whether the generated prediction values are consistent with the pixel value of the noticed pixel (that is, whether the prediction is correct) to the run counting part 514.

The plural prediction parts 512 of this example treat the pixel values of the respective peripheral pixels A to D exemplified in FIG. 3A as the prediction values. That is, the first prediction part 512A treats the pixel value of the peripheral pixel A as the prediction value, the second prediction part 512B treats the pixel value of the peripheral pixel B as the prediction value, the third prediction part 512C treats the pixel value of the peripheral pixel C as the prediction value, and the fourth prediction part 512D treats the pixel value of the peripheral pixel D as the prediction value. As exemplified in FIG. 3A, the peripheral pixels A to D are set on the basis of the noticed pixel X. Specifically, the first peripheral pixel A is a pixel adjacent to the noticed pixel X at the upstream side in the main scanning direction, and the second peripheral pixel B is a pixel adjacent to the noticed pixel X at the upstream side in the sub-scanning direction. Besides, the third peripheral pixel C is a pixel adjacent to the second peripheral pixel B at the upstream side in the main scanning direction, and the fourth peripheral pixel D is a pixel adjacent to the second peripheral pixel B at the downstream side in the main scanning direction.

As stated above, since the prediction part 512 of this example has the pixel values of the pixels adjacent to the noticed pixel X as the prediction values, especially in the computer graphics image (hereinafter referred to as the CG image), a high hitting ratio can be realized. Accordingly, a high compression ratio can be expected by the run-length coding process.

The run counting part 514 counts the continuous consistent number (run number) with respect to each of the prediction parts based on the prediction results inputted from the respective prediction parts 512.

Besides, in the case where input is made from all the prediction parts 512 to the effect that the prediction is not correct (that is, to the effect that the pixel value of the noticed pixel is not consistent with the prediction value), the run counting part 514 makes output to the selection part 520 to the effect that the prediction is not correct in all the prediction parts, and outputs the continuous consistent numbers of the respective prediction parts, which have been counted until now, to the longest run selection part 516.

When the continuous consistent numbers of the respective prediction parts are inputted from the run counting part 514, based on the continuous consistent numbers of the respective prediction parts, the longest run selection part 516 selects the combination of the continuous consistent numbers, which becomes optimum in the run-length coding process, and outputs the selected combination of the continuous consistent numbers as the optimum continuous consistent number to the entropy coding part 570.

In this example, since it is designed that as the continuous consistent number becomes long, the compression ratio becomes high, the longest run selection part 516 selects the maximum continuous consistent number (that is, the longest run) based on the continuous consistent numbers of the respective prediction parts, and outputs the selected longest run and the prediction part ID corresponding thereto to the entropy coding part 570.

As exemplified in FIG. 5B, the prediction error generation part 540 includes a prediction error calculation part 542, a prediction part 544, and a prediction correction part 546.

In the prediction error generation part 540, the prediction error calculation part 542 calculates a difference between the pixel value of the noticed pixel inputted from the image input part 500 and the prediction value (corrected prediction value) inputted from the prediction part 544, and outputs the calculated difference as the prediction error to the entropy coding part 570 and the context counting part 550.

The prediction part 544 holds the pixel value inputted from the image input part 500, uses the pixel value of the peripheral pixel around the noticed pixel to calculate the prediction value of the noticed pixel, corrects the calculated prediction value in accordance with the correction value inputted from the prediction correction part 546, and outputs the corrected prediction value to the prediction error calculation part 542.

Incidentally, the prediction method of the prediction part 544 in the prediction error generation part 540 may be identical with the prediction method of the prediction part 512 in the run-length generation part 510 or may be different one.

The prediction correction part 546 determines the correction value based on the count result of the prediction error inputted from the context counting part 524, and outputs the determined correction value to the prediction part 544.

[Coding Process]

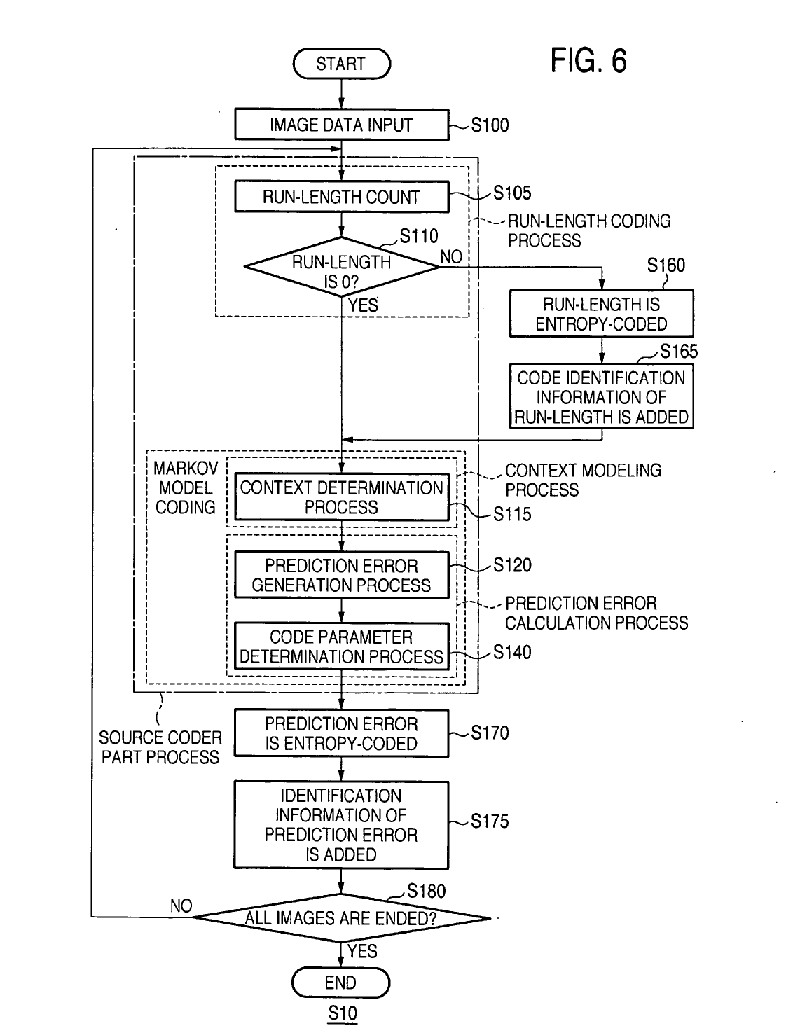

FIG. 6 is a flowchart of a first coding process (S10) performed by the coding program 5.

As shown in FIG. 6, at step 100 (S100), the image input part 500 acquires image data as a coding object from the outside, sets a noticed pixel X in scan sequence from the acquired image data, and outputs a pixel value of the noticed pixel X to the run-length generation part 510, the context determination part 530 and the prediction error generation part 540.

At step 105 (S105), the run-length generation part 510 holds pixel values inputted from the image input part 500 up to a predetermined number, and generates a prediction value of the noticed pixel X by using the held pixel values.

The run-length generation part 510 compares the pixel value of the noticed pixel X with the prediction value of the noticed pixel X while updating the noticed pixel X in the scan direction, and counts the continuous consistent number.

When the pixel value of the noticed pixel X is not consistent with the prediction value (that is, the run is interrupted), the run-length generation part 510 outputs the counted continuous consistent number to the selection part 520 and the entropy coding part 570.

At step 110 (S110), the selection part 520 judges whether the continuous consistent number inputted from the run-length generation part 510 is 0 or not, and in the case where the continuous consistent number is 0, the selection part 520 instructs the other components to code the prediction error, and a shift is made to a process of S115. In the case where the continuous consistent number is 1 or more, the selection part instructs the other components to code the prediction error after the continuous consistent number is coded, and a shift is made to a process of S160.

That is, the selection part 520 makes a control to perform the run-length coding process in the case where the pixel value of the noticed pixel X is consistent with the pixel value of any one of the peripheral pixels A to D (that is, in the case where the prediction is correct), and makes a control to perform the Markov model coding process in the case where the pixel value of the noticed pixel X is not consistent with any of the peripheral pixels A to D (that is, in the case where the prediction is not correct).

At step 115 (S115), the context determination part 530 determines the state (that is, the context) of the peripheral pixels A to D corresponding to the noticed pixel X in accordance with the instructions from the selection part 520, and outputs the determined context to the context counting part 550.

At step 120 (S120), the prediction error generation part 540 calculates the prediction value of the noticed pixel X based on the pixel value of any one of the peripheral pixels A to D, corrects the calculated prediction value in accordance with the count value of the prediction error, and calculates the prediction error based on the corrected prediction value.

The prediction error generation part 540 outputs the calculated prediction error to the context counting part 550 and the entropy coding part 570.

At step 140 (S140), the context counting part 550 counts the context inputted from the context determination part 530 by a specified method, and counts the prediction error inputted from the prediction error generation part 540 by a specified method. The count value of the prediction error is inputted to the prediction error generation part 540 and the code table generation part 560, and the count value of the context is inputted to the code table generation part 560.

The code table generation part 560 generates the code table based on the count value of the context and the count value of the prediction error, and outputs the generated code table to the entropy coding part 570. More specifically, the code table generation part 560 calculates the code parameter to generate the Golomb code based on the count value of the context and the count value of the prediction error, and outputs the calculated code parameter to the entropy coding part 570.

At step 160 (S160), the entropy coding part 570 converts the continuous consistent number (run number) inputted from the run-length generation part 510 into the Huffman code.

At step 165 (S165), the identification information addition part 590 generates the code identification information of the run-length coding system, and outputs the generated code identification information to the entropy coding part 570.

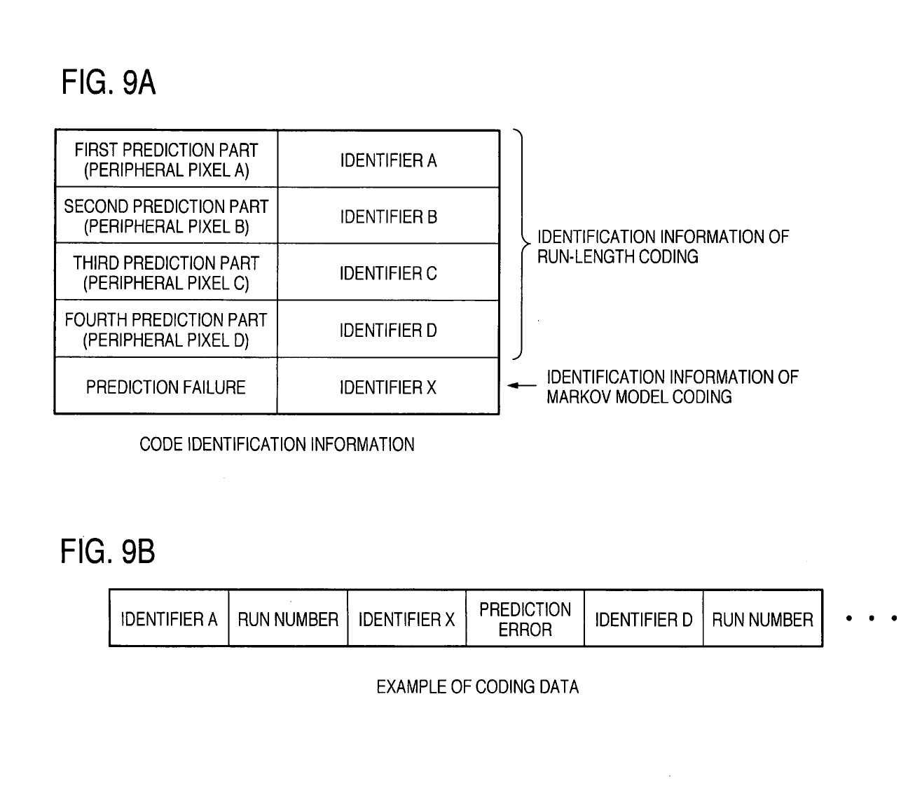

Incidentally, in this example, as exemplified in FIG. 9A, in order to use the prediction part ID (identifier A to identifier D) outputted from the run-length generation part 510 as the code identification information of the run-length coding system, the identification information addition part 590 outputs the prediction part ID corresponding to the continuous consistent number to the entropy coding part 570.

The code output part 580 causes the code of the continuous consistent number inputted from the entropy coding part 570 to correspond to the code of the code identification information (in this example, the prediction part 1D), and outputs it to the outside (for example, the storage device or the like). That is, as exemplified in FIG. 9B, the code of the run number (“run number” in the drawing) is associated with any one of the identifiers A to D corresponding to the prediction part.

At step 170 (S170), the entropy coding part 570 converts the prediction errors inputted from the prediction error generation part 540 into the Golomb codes, and outputs these codes to the code output part 58.

Incidentally, in the case where the prediction error inputted from the prediction error generation part 540 is coded, the entropy coding part 570 uses the code parameter inputted from the code table generation part 560 to generate the Golomb code corresponding to the inputted prediction error.

At step 175 (S175), the identification information addition part 590 generates the code identification information to identify the coding system (that is, the Markov model coding system) selected by the selection part 520, and outputs the generated code identification information to the entropy coding part 570.

Incidentally, the identification information addition part 590 of this example generates, as the code identification information of the Markov model coding system, the information (identifier X exemplified in FIG. 9) indicating that the prediction is not correct, and outputs the generated code identification information to the entropy coding part 570. The code identification information inputted to the entropy coding part 570 is entropy-coded.

The code output part 580 causes the code of the prediction error inputted from the entropy coding part 570 to correspond to the code of the code identification information (identifier X) and outputs it to the outside (for example, the storage device or the like) That is, as exemplified in FIG. 9B, the code (“prediction error” in the drawing) of the prediction error is associated with the identifier X corresponding to the Markov model coding system.

At step 180 (S180), the coding program 5 judges whether the whole image data of the coding object is coded or not, and in the case where the whole thereof is coded, the coding process is ended (S10), and in the case where there are pixels not coded, a next pixel in the scan order is made a noticed pixel X, and a return is made to the process of S105.

Next, a prediction error generation process (S120) shown in FIG. 6 will be described.

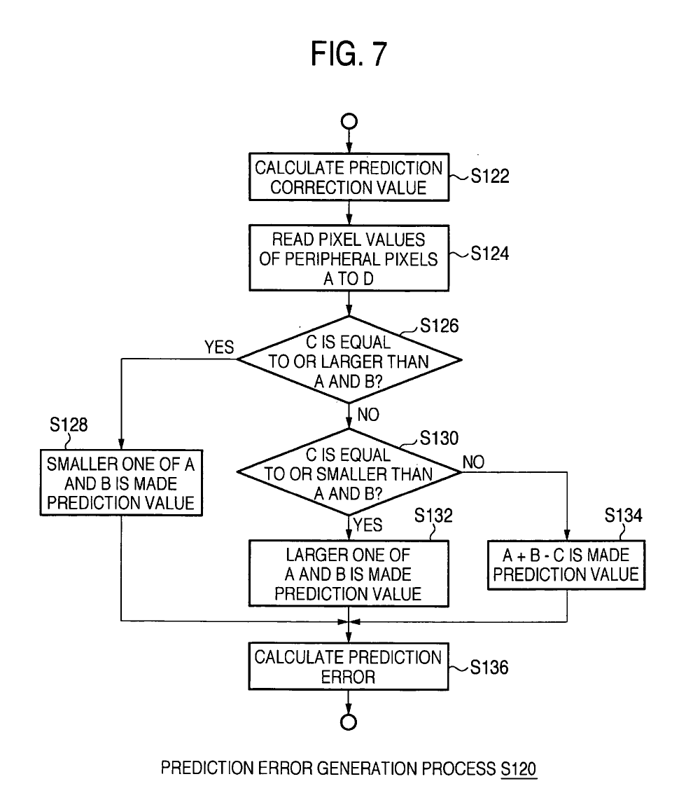

FIG. 7 is a flowchart for explaining in more detail the prediction error generation process (S120) explained in FIG. 6.

As shown in FIG. 7, at step 122 (S122), the context counting part 550 counts the prediction errors inputted from the prediction error calculation part 540 until now, and outputs the count value of the prediction errors to the prediction correction part 546 (FIG. 5B).

The prediction correction part 546 determines the correction value of the prediction value based on the count value of the prediction error inputted from the context counting part 540, and outputs the determined correction value of the prediction value to the prediction part 544.

At step 124 (S124), the prediction part 544 (FIG. 5B) reads the pixel values of the plural peripheral pixels A to D corresponding to the noticed pixel X.

At step 126 (S126), the prediction part 544 compares the read pixel values of the peripheral pixels A, B and C, and in the case where the pixel value of the peripheral pixel C is not smaller than the peripheral pixel A and not smaller than the peripheral pixel B, a shift is made to a process of S128, and in the case where the pixel value of the peripheral pixel C is smaller than either the peripheral pixel A or the peripheral pixel B, a shift is made to a process of S130.

At step 128 (S128), the prediction part 544 compares the pixel value of the peripheral pixel A with the pixel value of the peripheral pixel B, and regards the smaller pixel value as a temporary prediction value.

Next, the prediction part 544 adds a correction value inputted from the prediction correction part 546 to the temporary prediction value, calculates a true prediction value, and outputs the calculated true prediction value to the prediction error calculation part 542.

At step 130 (S130), the prediction part 544 compares the read pixel values of the peripheral pixels A, B and C with each other, and in the case where the pixel value of the peripheral pixel C is not larger than the peripheral pixel A and not larger than the peripheral pixel B, a shift is made to a process of S132, and in the case where the pixel value of the peripheral pixel C is larger than either the peripheral pixel A or the peripheral pixel B, a shift is made to a process of S134.

At step 132 (S132), the prediction part 544 compares the pixel value of the peripheral pixel A with the pixel value of the peripheral pixel B, regards the larger pixel value as a temporary prediction value, adds a correction value inputted from the prediction correction part 546 to the temporary prediction value to calculate a true prediction value, and outputs the calculated true prediction value to the prediction error calculation part 542.

At step 134 (S134), the prediction part 544 adds the pixel value of the peripheral pixel A and the pixel value of the peripheral pixel B, and subtracts the pixel value of the peripheral pixel C from this added value to calculate a temporary prediction value.

Next, the prediction part 544 adds a correction value inputted from the prediction correction part 546 to the calculated temporary prediction value to calculate a true prediction value, and outputs the calculated true prediction value to the prediction error calculation part 542.

At step 136 (S136), the prediction error calculation part 542 calculates a difference between the prediction value (prediction value after the correction) inputted from the prediction part 544 and the pixel value of the noticed pixel X, and outputs the calculated difference as a prediction error to the entropy coding part 570 and the context counting part 550.

Next, the code parameter generation process (S140) shown in FIG. 6 will be described

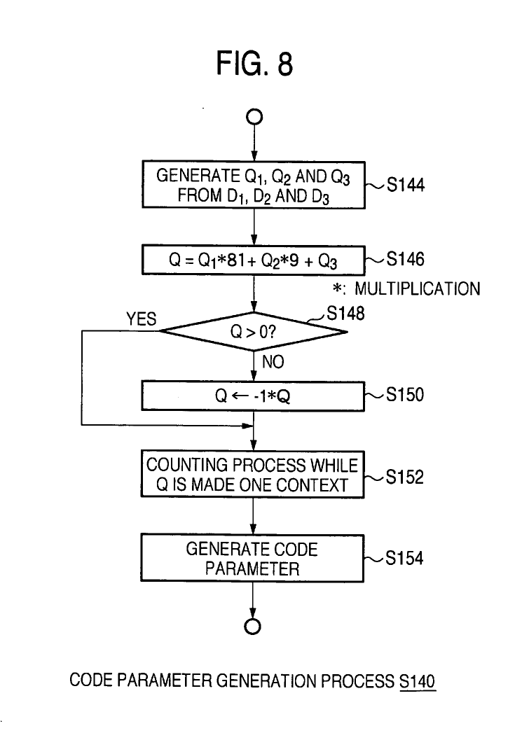

FIG. 8 is a flowchart for explaining in more detail the code parameter generation process (S140) explained in FIG. 6.

As shown in FIG. 8, at step 144 (S144), the context determination part 530 judges which of nine numerical sections the difference value D₁, the difference value D₂ and the difference value D₃ calculated at S115 (FIG. 6) belongs to, and calculates partial context values Qₙ corresponding to the judged numerical sections. The partial context values Qₙ of this example correspond to the nine respective numerical sections, and are nine integers of from −4 to +4.

The context determination part 530 calculates the partial context values Q₁, Q₂ and Q₃ with respect to the difference value D₁, the difference value D₂ and the difference value D₃.

At step 146 (S146), the context determination part 530 uses the calculated partial context values Q₁, Q₂ and Q₃ to calculate the context value Q of the noticed pixel X. Specifically, the context value Q is calculated by the following expression.
Q=Q₁×81+Q₂×9+Q₃

The context determination part 530 outputs the calculated context value Q to the context counting part 550.

At step 148 (S148), the context counting part 550 judges whether the context value Q inputted from the context determination part 530 is larger than 0 or not, and in the case where the context value Q is larger than 0, a shift is made to a process of S152, and in the case where the context value Q is 0 or smaller, a shift is made to a process of S150.

At step 150 (S150), the context counting part 550 multiplies the context value Q by (−1). That is, the context counting part 550 calculates the absolute value of the negative context value Q, and regards the calculated absolute value as the context value Q.

At step 152 (S152), the context counting part 550 treats the context value Q calculated with respect to the noticed pixel X as one context and counts the number of times of appearance of the context value by a fixed method.

Besides, the context counting part 550 counts the prediction error inputted from the prediction error generation part 540, and outputs the count value of the prediction error and the count value of the context value to the code table generation part 560.

At step 154 (S154), the code table generation part 560 dynamically generates the code table based on the count value of the prediction error inputted from the context counting part 550 and the count value of the context value.

Specifically, the code table generation part 560 calculates the code parameter to generate the Golomb code based on the count value of the prediction error and the count value of the context value, and outputs the calculated code parameter to the entropy coding part 570.

As stated above, the first coding program 5 compares the pixel value of the noticed pixel X with the pixel values of the peripheral pixels A to D, and in the case where the pixel value is consistent with the pixel value of any one of the peripheral pixels, the run-length coding process is performed, and in the case where the pixel value is not consistent with any pixel values of the peripheral pixels, the Markov model coding process is performed.

That is, only in the case where the pixel value is not consistent with any pixel values of the peripheral pixels, the first coding program 5 calculates the context value and the prediction error for each noticed pixel, counts the calculated context value and the prediction error respectively by the predetermined method, and dynamically generates the code corresponding to the count value of the context value and the count value of the prediction error, and therefore, the total coding process can be performed at high speed.

Next, a decoding program in the first embodiment and the operation of the decoding program will be described.

[Decoding Program]

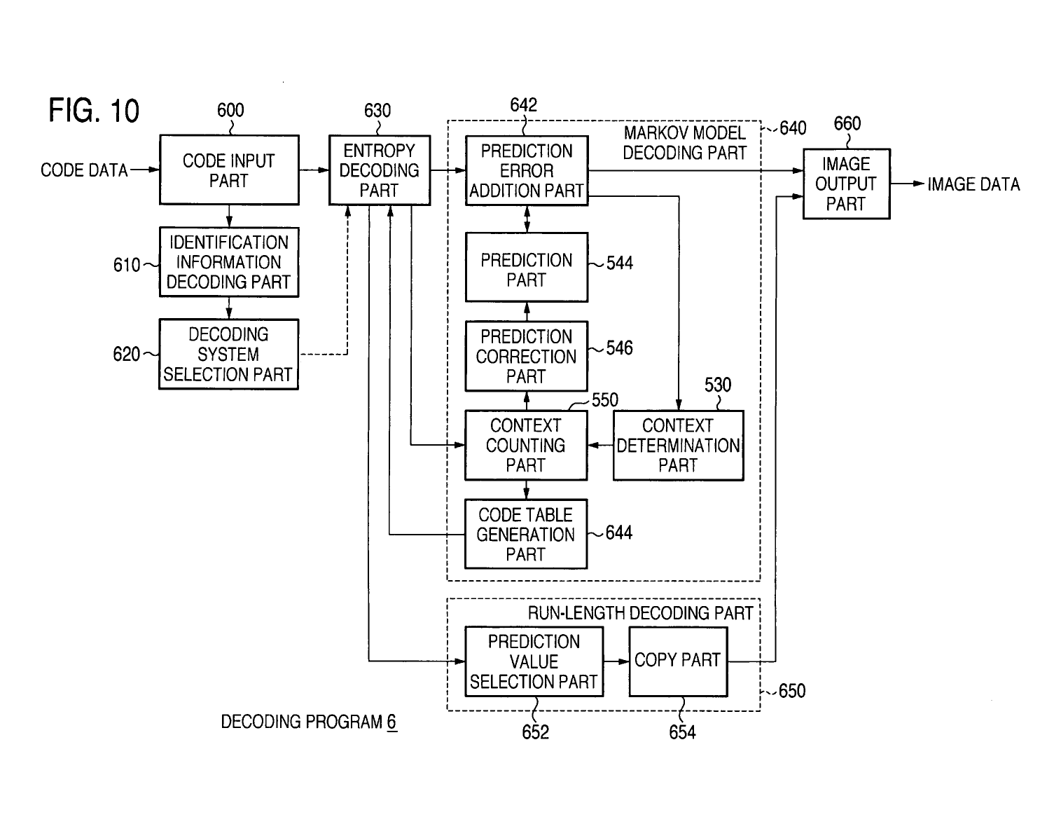

FIG. 10 is a view exemplifying a structure of a decoding program 6 in the first embodiment. Incidentally, in respective components shown in the drawing, those substantially equal to the components shown in FIG. 4 are denoted by the same reference numerals.

As exemplified in FIG. 10, the first decoding program 6 includes a code input part 600, an identification information decoding part 610, a decoding system selection part 620, an entropy decoding part 630, a Markov model decoding part 640, a run-length decoding part 650 and an image output part 660.

Besides, the Markov model decoding part 640 includes a prediction error addition part 642 and a code table generation part 644 in addition to a context determination part 530 and a context counting part 550 explained with reference to FIG. 4, and a prediction part 544 and a prediction correction part 546 explained with reference to FIG. 5B.

Besides, the run-length decoding part 650 includes a prediction value selection part 652 and a copy part 654.

Incidentally, the entropy decoding part 630 and the Markov model decoding part 640 of this example are an example of a first decoding unit of the invention, and the entropy decoding part 630 and the run-length decoding part 650 are an example of a second decoding unit of the invention.

In the decoding program 6, the code input part 600 acquires code data as a decoding object, and outputs a partial code (hereinafter simply referred to as a code) as a process object in the acquired code data to the identification information decoding part 610 and the entropy decoding part 630 in sequence. More specifically, the code input part 600 outputs the code of the code identification information in the partial code (code) to the identification information decoding part 610, and outputs the code of the run number or the prediction error to the entropy decoding part 630.

The identification information decoding part 610 decodes the code of the code identification information inputted from the code input part 600, and outputs the decoded code identification information to the decoding system selection part 620.

The decoding system selection part 620 (decoding selection unit) selects the decoding system to be applied based on the code identification information added to the code data. Specifically, the decoding system selection part 620 determines a generation method of a code table in accordance with the code identification information (identifiers A to D or identifier X) inputted from the identification information decoding part 610, and notifies the entropy decoding part 630 of the determined generation method.

The decoding system selection part 620 of this example instructs the entropy decoding part 630 to use the code table of the Huffman code in the case where the identifiers A to D are inputted from the identification information decoding part 610, and instructs the entropy decoding part 630 to use the code table (specifically, decode parameter) of the Golomb code in the case where the identifier X is inputted from the identification information decoding part 610.

Incidentally, the inputted identifiers A to D are inputted to the run-length decoding part 650 through the entropy decoding part 630.

The entropy decoding part 630 uses the code table instructed from the decoding system selection part 620, and entropy-decodes the code inputted from the code input part 600. That is, when instructed to use the code table of the Huffman code by the decoding system selection part 620, the entropy decoding part 630 uses the code table of the Huffman code to perform the decoding process, and when instructed to use the code table of the Golomb code by the decoding system selection part 620, the entropy decoding part 630 uses the decode parameter inputted from the code table generation part 644 to perform the decoding process. The decode parameter is a parameter to decode the Golomb code.

The decoded data becomes the run number or the prediction error.

The entropy decoding part 630 outputs the decoded data to the Markov model decoding part 640 or the run-length decoding part 650 in accordance with the decoding system selected by the decoding system selection part 620. That is, in the case where the decoding system selection part 620 receives any one of the identifiers A to D, the entropy decoding part 630 outputs the decoded data value (that is, the run number), together with the identifier, to the run-length decoding part 650, and in the case where the decoding system selection part 620 receives the identifier X, the entropy decoding part outputs the decoded data value (that is, the prediction error) to the Markov model decoding part 640.

The Markov model decoding part 640 generates the decoded data (pixel value of the noticed pixel) based on the prediction error of the noticed pixel inputted from the entropy decoding part 630 and the context of the noticed pixel, and outputs the generated decoded data to the image output part 660.

The Markov model decoding part 640 judges the context based on the generated decoded data, calculates the decode parameter (that is, the code table) to determine the decode value corresponding to the code and the correction parameter to correct the prediction value based on the judged context, and outputs the calculated decode parameter to the entropy decoding part 630.

More specifically, the prediction error addition part 642 adds the prediction error inputted from the entropy decoding part 630 and the prediction value inputted from the prediction part 544, and outputs the added value as the pixel value of the noticed pixel X to the image output part 660, the context determination part 530, and the prediction part 544.

The context determination part 530 uses the decoded data (that is, the pixel value) inputted from the prediction error addition part 642 to calculate the context value indicating the change state of the pixel value, and outputs the calculated context value to the context counting part 550.

The context counting part 550 counts the context value inputted from the context determination part 530 and the prediction error inputted from the entropy decoding part 630, and outputs the count result to the code table generation part 644 and the prediction correction part 546.

The code table generation part 644 generates the code table (in this example, the decode parameter) based on the count result inputted from the context counting part 550, and outputs the generated code table (decode parameter) to the entropy decoding part 630.

The prediction part 544 of the Markov model decoding part 640 holds the pixel values inputted from the prediction error addition part 642, selects the pixel value of the peripheral pixel located around the noticed pixel X from the held pixel values, uses the selected pixel value of the peripheral pixel to calculate the prediction value of the noticed pixel X, corrects the calculated prediction value in accordance with the correction value inputted from the prediction correction part 546, and outputs the corrected prediction value to the prediction error addition part 642. That is, the prediction part 544 holds the pixel values sequentially decoded by the prediction error addition part 642 up to a predetermined number, and uses the other held pixel values (pixel values of the peripheral pixels) to generate the prediction value of the noticed pixel.

The prediction correction part 546 of the Markov model decoding part 640 determines the correction value based on the count result of the prediction error inputted from the context counting part 550, and outputs the determined correction value to the prediction part 544.

The run-length decoding part 650 generates the decoded data (that is, the pixel value of the noticed pixel) based on the identifier inputted from the entropy decoding part 630 and the run number.

More specifically, the prediction value selection part 652 holds the already decoded pixel values up to the predetermined number, reads from the held pixel values the pixel value of the peripheral pixel corresponding to the identifier inputted from the entropy decoding part 630, and outputs the read pixel value and the inputted run number to the copy part 654.

The copy part 654 makes copies of the pixel value inputted from the prediction value selection part 652, by the number of which is equal to the run number inputted from the prediction value selection part 652, and outputs the respective copied pixel values as the pixel values of the noticed pixels to the image output part 660 in sequence.

The image output part 660 outputs the decoded data (that is, the pixel value of the noticed pixel) inputted from the Markov model decoding 640 or the run-length decoding part 650 to the outside in sequence.

[Decoding Process]

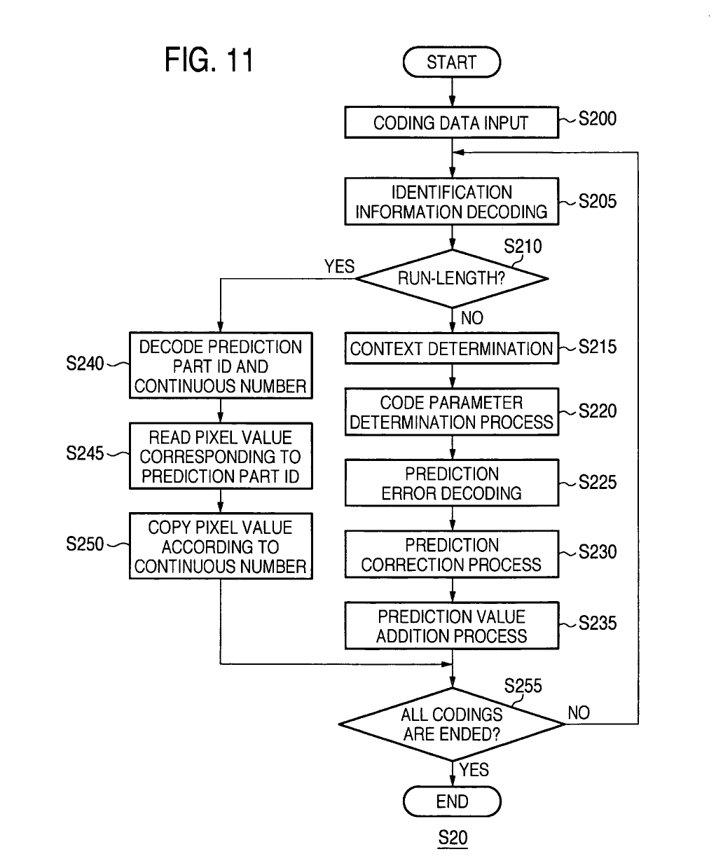

FIG. 11 is a flowchart of a first decoding process (S20) performed by the decoding program 6.

As shown in FIG. 11, at step 200 (S200), the code input part 600 acquires code data as a decoding object from the outside, outputs a code of code identification information in the acquired code data to the identification information decoding part 610, and outputs the code of the run number or the prediction error to the entropy decoding part 630.

At step 205 (S205), the identification information decoding part 610 decodes the code of the code identification information inputted from the code input part 600, and outputs the decoded code identification information (identifier) to the coding system selection part 620.

At step 210 (S210), in the case where the code identification information inputted from the identification information decoding part 610 is any one of the identifiers A to D (that is, in the case of the identification information of the run-length coding system), the decoding system selection part 620 instructs the other components of the decoding program 6 to perform the decoding process by the run-length coding system, and in the case where the code identification information inputted from the identification information decoding part 610 is the identifier X (that is, in the case of the identification information of the Markov model coding system), the decoding system selection part instructs the other components of the decoding program 6 to perform the decoding process by the Markov model coding system.

In the decoding program 6, in the case where the code identification information inputted from the identification information decoding part 610 is any one of the identifiers A to D, a shift is made to the process of S240, and in the case where the code identification information inputted from the identification information decoding part 610 is the identifier X, a shift is made to the process of S215.

At step 215 (S215), the Markov model decoding part 640 refers to the pixel values of the already decoded pixels, and determines the state (that is, the context) of the peripheral pixels A to D corresponding to the noticed pixel X.

At step 220 (S220), the Markov model decoding part 640 counts the determined context by a predetermined method, and further counts the prediction error inputted from the entropy decoding part 630 until now by the predetermined method, generates the code table (that is, the decode parameter) based on these count values, and outputs the generated code table (decode parameter) to the entropy decoding part 630.

At step 225 (S225), the entropy decoding part 630 uses the code table (that is, the decode parameter) inputted from the code table generation part 644 to entropy-decode the code of the prediction error inputted from the code input part 600, and outputs the decoded data value (that is, the prediction error) to the Markov model decoding part 640 (specifically, the prediction error addition part 642 and the context counting part 550).

At step 230 (S230), the Markov model decoding part 640 (the prediction correction part 546) determines the correction value based on the count value (prediction error counted by the context counting part 524) of the prediction error.

Next, the Markov model decoding part 640 (prediction part 544) reads the peripheral pixels A to D corresponding to the noticed pixel X from the pixel values decoded until now, calculates the prediction value of the noticed pixel X based on the pixel value of the read peripheral pixel, and corrects the calculated prediction value in accordance with the determined correction value.

At step 235 (S235), the Markov model decoding part 640 (prediction error addition part 642) adds the prediction value (corrected) of the noticed pixel X and the prediction error of the noticed pixel X inputted from the entropy decoding part 630, and outputs the added value as the pixel value of the noticed pixel X to the image output part 660.

The image output part 660 outputs the pixel value of the noticed pixel X inputted from the Markov model decoding part 640 to the outside (for example, the storage device or the like).

At step 240 (S240), the entropy decoding part 630 decodes the code of the run number in accordance with the instruction of the decoding system selection part 620, and outputs the decoded run number and the identifier to the run-length decoding part 650.

At step 245 (S245), the run-length decoding part 650 (the prediction value selection part 652) reads, from the pixel values decoded until now, the pixel value corresponding to the identifier inputted from the entropy decoding part 630. That is, the run-length decoding part 650 reads the pixel value located at the position of the peripheral pixel corresponding to the identifier.

At step 250 (S250), the run-length decoding part 650 (copy part 654) generates the pixel values corresponding to the identifier, by the number of which is equal to the run number, and outputs at least one generated pixel value as the pixel value of the noticed pixel to the image output part 660.

The image output part 660 outputs the pixel value of at least one noticed pixel X inputted from the run-length decoding part 650 to the outside (for example, the storage device or the like).

At step 255 (S255), the decoding program 6 judges whether all the code data as the decoding object are decoded or not, and in the case where all the code data are decoded, the decoding process (S20) is ended, and in the case where there are codes not decoded, a next code is made as the code of the noticed pixel X, and a return is made to the process of S205.

[Evaluation]

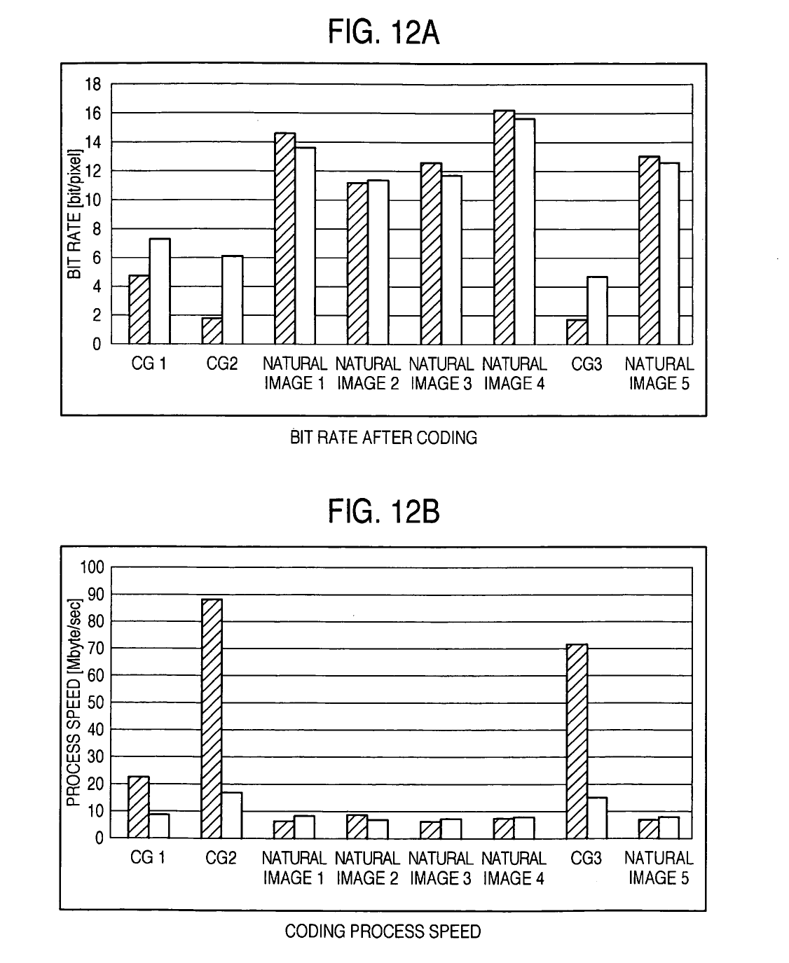

FIG. 12A is a graph showing bit rates of image data coded by the first coding program 5 and bit rates of image data coded by the coding program 9 based on the Markov model. FIG. 12B is a graph showing coding process speeds of the first coding program 5 and coding process speeds of the coding program 9 based on the Markov model.

The bit rates and the coding process speeds shown in FIGS. 12A and 12B are experimental results of a coding experiment performed by using eight kinds of images (multi-value [24 bit/pixel] images).

Incidentally, the unit of the bit rate is [bit/pixel], and the unit of the coding process speed is [Mbyte/sec]

As shown in FIGS. 12A and 12B, it is understood that with respect to the natural images, the first coding program 5 has the compression ratio and the process speed comparable to the coding program 9 based on the Markov model, and with respect to the CG images, it has the performance significantly higher than the coding program 9 in both the compression ratio and the process speed.

Next, a comparison between the first coding program 5 and the coding program 9 will be theoretically performed.

A source coder part total process time T_{jpeg}[sec/pixel] per pixel of the coding program 9 is expressed by the following mathematical expression 1. Where, T_{f} denotes a context modeling process time [sec/pixel], Tᵣ denotes a run-length coding process time [sec/pixel], Tₚ denotes a predictive coding process time [sec/pixel], P_{f} denotes a context flat ratio, and Nᵣ denotes an average run-length length. Here, the context flat ratio is the ratio of the context of (D₁, D₂, D₃)=(0, 0, 0) to all the contexts.

Besides, in the mathematical expression 1, T_{f}>>Tᵣ, Tₚ>>Tᵣ, and Nᵣ>1 are established in general. Thus, when the run-length coding ratio P_{f} can be made large, the source coder process time T_{jpeg} can be shortened.
T_{jpeg}=P_{f}(T_{f}+TᵣNᵣ)/Nᵣ+(1−P_{f}) (T_{f}+Tₚ) . . . (mathematical expression 1)

However, substantially, there hardly occurs a case of (D₁, D₂, D₃)=(0, 0, 0), and P_{f} is small. Thus, consequently, the process time T_{jpeg} of the coding program 9 is relatively large.

Next, a source coder part process time T [sec/pixel] per pixel of the first coding program 5 is expressed by mathematical expression 2. Where, T_{f} denotes a context modeling process time [sec/pixel], Tᵣ denotes a run-length coding process time [sec/pixel], Tₑ denotes a prediction error calculation process time [sec/pixel], and Pₕ denotes a prediction hitting ratio at the time of run-length coding.
T=PₕTᵣ+(1−Pₕ)(T_{f}+Tₑ) . . . (mathematical expression 2)

Next, in order to compare the mathematical expression 1 and the mathematical expression 2, a difference between T_{jpeg} and T is calculated. Incidentally, when it is assumed that the coding program 5 and the coding program 9 use the same prediction error calculation expression, since Tₑ≈Tₚ is established, the difference between T_{jpeg} and T is expressed by the following expression 3.
T_{jpeg}−T=P_{f}T_{f}/Nᵣ+(Pₕ−P_{f})(T_{f}+Tₑ−Tᵣ) . . . (mathematical expression 3)

Next, the reason why T_{jpeg}>T is established will be described using the mathematical expression 3.

First, the first term on the right side of the mathematical expression 3 will be described.

The first term on the right side is a term not influenced by the content of the run-length coding process of the coding program 5. Accordingly, the coding program 5 is shorter in process time than the coding program 9 by at least the first term on the right side. Especially, in the coding program 9, as P_{f} becomes large or Nᵣ becomes small, the process time difference from the coding program 5 becomes larger.

Next, a second term on the right side of the mathematical expression 3 will be described.

In general, T_{f}+Tₑ>>Tᵣ is established. Besides, in the case where the Markov model coding part (FIG. 4) uses the peripheral pixels A to D near the noticed pixel to perform the coding process, since Pₕ>P_{f} is established, the second term on the right side is a positive value. Further, as compared with Pₕ and P_{f}, it is conceivable that T_{f}, Tₑ and Tᵣ are hardly influenced by the input image, and accordingly, when Pₕ can be made large, the process time difference between the coding program 5 and the coding program 9 becomes further large.

In view of the above, T_{jpeg}>T is established, and the coding program 5 of this embodiment can realize shortening of the calculation process time as compared with the coding program 9 based on the Markov model.

### Second Embodiment

Next, a second embodiment will be described.

For the following description, an input image as a coding object is roughly classified into two kinds based on the feature. The first classification is an image generated by a computer (that is, a CG image), and the second classification is an image optically read by a digital camera, a scanner or the like (that is, a natural image).

In general, in the CG image, the same pixel value often exists in adjacent pixels, and pixel values used are often biased toward a specific value. On the other hand, the natural image has the feature that even adjacent pixels seldom have the same pixel value.

Thus, in the natural image, there is a low possibility that the pixel value of the noticed pixel X is consistent with the pixel values of the peripheral pixels A to D, and there is a tendency that the continuous consistent number (run number) of the run-length coding process is interrupted by “prediction failure”. On the other hand, in the CG image, there is a high possibility that the pixel value of the noticed pixel X is consistent with the pixel values of the peripheral pixels A to D, and there is a tendency that the continuous consistent number of the run-length coding process becomes large.

As a result, it can be said that in fact, the coding process in the first embodiment applies the run-length coding to the portion corresponding to the CG image and applies the Markov model coding to the portion corresponding to the natural image.

In general, in the Markov model coding, various data are count-processed for every context, and a code parameter used at the time of entropy coding is determined. Also in the Markov model coding part of the coding program 5, the prediction error value, the number of times of context appearance, and the like are count-processed, and the optimum Golomb code parameter (code parameter) is calculated for every context.

However, in the case where the input image is the natural image, a difference hardly exists between the optimum code parameters of the respective contexts. Thus, when only the context is determined, the optimum code parameter can be uniquely calculated, and the count process can be omitted.

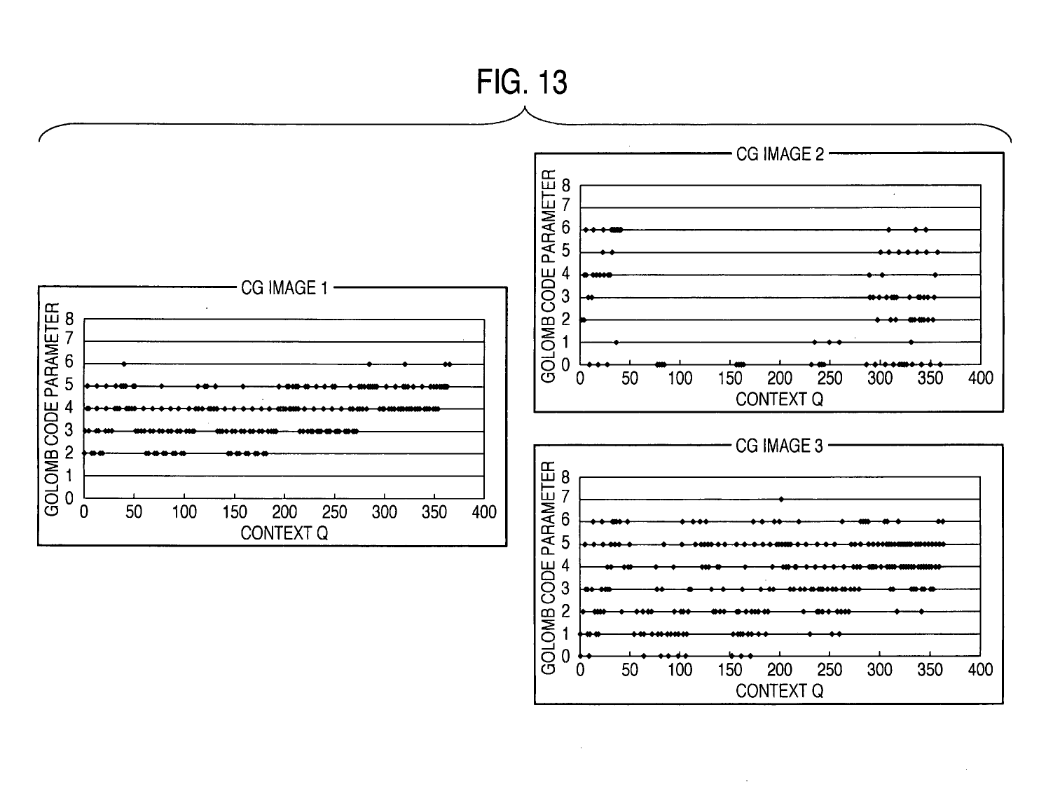

FIG. 13 is a graph showing a relation between the context value Q relating to the CG image and the code parameter.

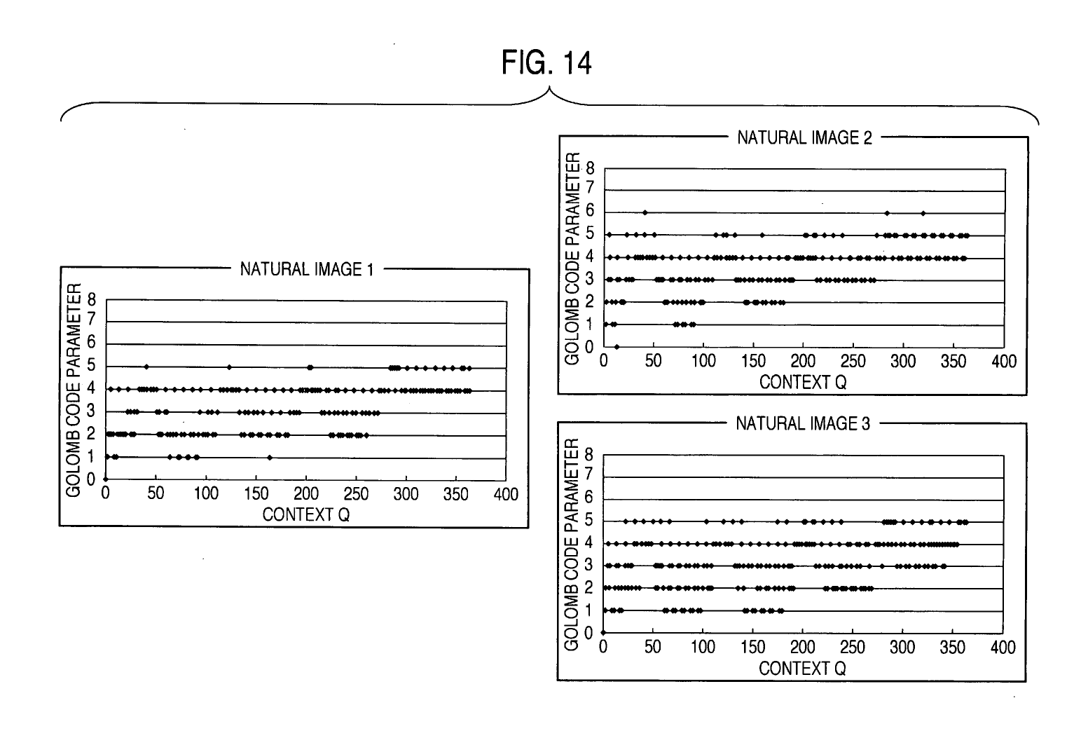

FIG. 14 is graph showing a relation between the context value Q relating to the natural image and the code parameter.

As is understood from the reference to FIG. 13, in the case where the CG image is coded using the first coding program 5, it is understood that the distribution of the code parameter (that is, the Golomb code parameter) varies according to the image. For example, in a CG image 1, the code parameter is distributed within a narrow range of 2 to 5, in a CG image 2, the code parameter is unevenly distributed relatively close to 0, and in a CG image 3, the code parameter is scattered within a wide range of 0 to 6. As stated above, the code parameter (Golomb code parameter) varies according to the image.

On the other hand, as is understood from the reference to FIG. 14, in the natural image, when the contexts are equal to each other, the Golomb code parameters used are close to each other between images. Thus, in the case where the natural image is inputted, even if the count process is not performed for every context and the code parameter is not calculated, a suitable code parameter can be uniquely determined from only the context for any images.

In a coding program 52 (described later) of the second embodiment, in the case where the Markov model coding process is performed, the context is count-processed, the code parameter is uniquely determined from only the context without calculating the code parameter, and the determined code parameter is used to code the image data.

By this, since the complicated count process for every context and the code parameter calculation process can be omitted, the process load and the amount of memory used can be reduced, and the process time can be shortened.

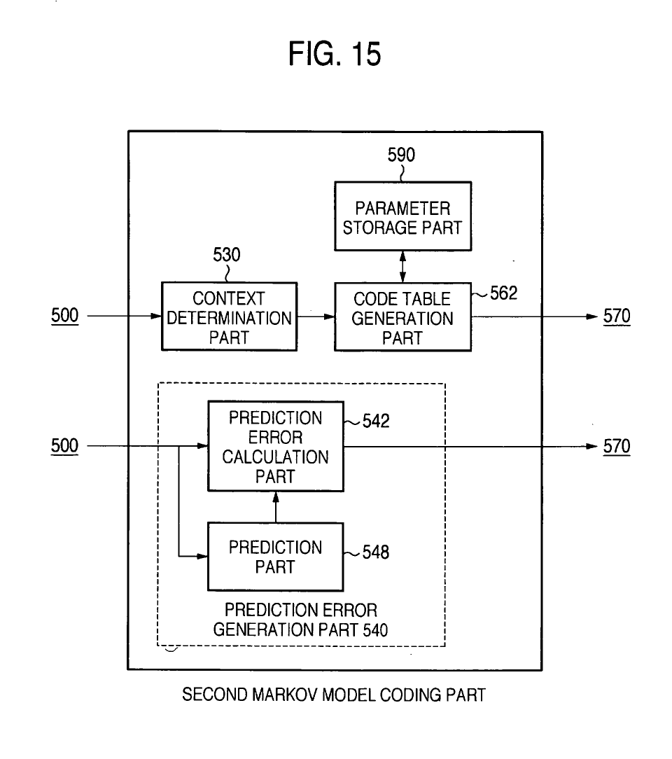

FIG. 15 is a view exemplifying a structure of a second Markov model coding part. That is, the second coding program 52 in the second embodiment has such a structure that in the first coding program 5 shown in FIG. 4, the Markov model coding part is replaced by the second Markov model coding part exemplified in FIG. 15. Incidentally, in respective components shown in the drawing, those substantially equal to the components shown in FIGS. 4 or 5 are denoted by the same reference numerals.

In the second Markov model coding part, a second code table generation part 562 (code group selection unit) refers to a parameter storage part 590, selects a code table (in this example, a code parameter) corresponding to a context determined by a context determination part 530, and outputs the selected code table (code parameter) to the entropy coding part 570.

The parameter storage part 590 stores plural code tables respectively made to correspond to the contexts. The code table stored in the parameter storage part 590 causes the code groups different from each other (for example, code groups corresponding to the same data and different in code length) to correspond to the data values.

The parameter storage part 590 of this example stores plural code parameters respectively made to correspond to the context values Q. These code parameters are parameters used for creating the Golomb codes.

A second prediction part 548 calculates the prediction value of the noticed pixel X based on the pixel values of the peripheral pixels A to D, and outputs the calculated prediction value to a prediction error calculation part 542. That is, the second prediction part 548 outputs the prediction value calculated by using any one of the peripheral pixel A to D directly to the prediction error calculation part 542 without correcting the prediction value.

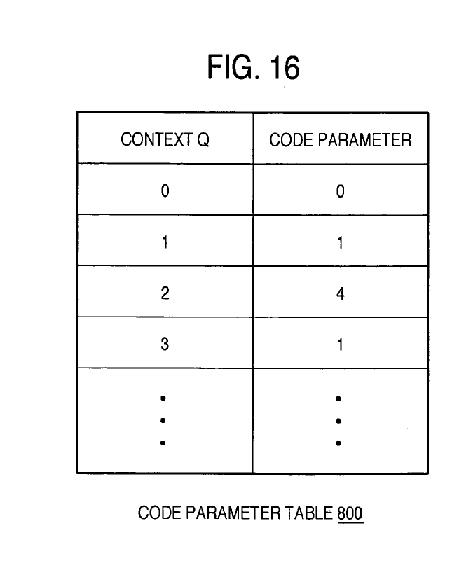

FIG. 16 is a view exemplifying the code parameters stored in the parameter storage part 590.

As exemplified in FIG. 16, the parameter storage part 590 of this example stores a code parameter table 800 (correspondence table) in which the code parameter corresponds to the context value Q. The context value Q included in the code parameter table 800 is the absolute value of one context value determined by the context determination part 530.

Next, a coding process (S30) by the second coding program 52 will be described.

Although the second coding process (S30) is roughly identical with the first coding process (S10) shown in FIG. 6, there is a difference between them in that the correction of the prediction value is not performed in the prediction error generation process (S120), and the first code parameter generation process (S140) is replaced by a fixed second code parameter generation process (S340).

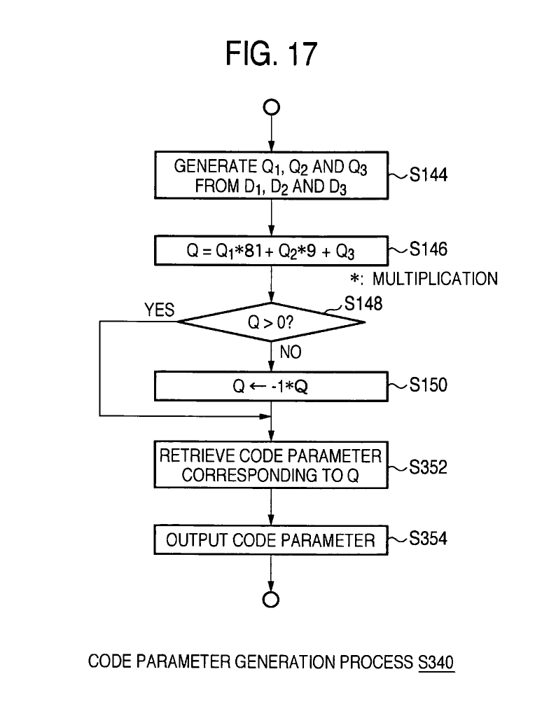

FIG. 17 is a flowchart for explaining the second code parameter generation process (S340). Incidentally, in respective processes shown in the drawing, processes substantially equal to the processes shown in FIG. 8 are denoted by the same reference characters.

As shown in FIG. 17, at step 144 (S144), the context determination part 530 (FIG. 15) judges which of nine numerical sections the difference value D₁, the difference value D₂ and the difference value D₃ calculated at S115 (FIG. 6) belong to, and calculates the partial context value Qₙ corresponding to the judged numerical section.

At step 146 (S146), the context determination part 530 uses the calculated partial context values Q₁, Q₂ and Q₃, and calculates the context value Q of the noticed pixel X. Specifically, the context value is calculated by the following expression.
Q=Q₁×81+Q₂×9+Q₃

At step 148 (S148), the context determination part 530 (FIG. 15) judges whether or not the calculated context value Q is larger than 0, and in the case where the context value Q is larger than 0, a shift is made to the process of S352, and in the case where the context value Q is 0 or less, a shift is made to the process of S150.

At step 150 (S150), the context determination part 530 multiplies the context value Q by (−1). That is, the context determination part 522 calculates the absolute value of the negative context value Q, and treats the calculated absolute value as the context value Q.

At step 352 (S352), the context determination part 530 (FIG. 15) outputs the calculated context value Q to the code table generation part 562.

The code table generation part 562 (FIG. 15) refers to the code parameter table 800 (FIG. 16) stored in the parameter storage part 590, and reads the code parameter corresponding to the context value Q inputted from the context determination part 530.

At step 354 (S354), the code table generation part 562 outputs the read code parameter as the code table to the entropy coding part 570 (FIG. 4).

Incidentally, although the parameter storage part 590 of this example stores the code parameter (Golomb code parameter) corresponding to the context value Q, the invention is not limited to this. For example, a code table in which a code corresponds to a data value each other corresponds to the context value Q and may be stored, and in this case, the code table generation part 562 reads the code table corresponding to the context value Q from the parameter storage part 590, and outputs it to the entropy coding part 570.

That is, the Markov model coding part of this embodiment reads the code parameter corresponding to the context value Q itself from the fixed code parameter table 800. By this, the count process of the context value and the count process of the prediction error become unnecessary.

Accordingly, the second Markov model coding part (FIG. 15) can generate the code table (code parameter) corresponding to the context at a process load lower than the first Markov model coding part (FIG. 4).

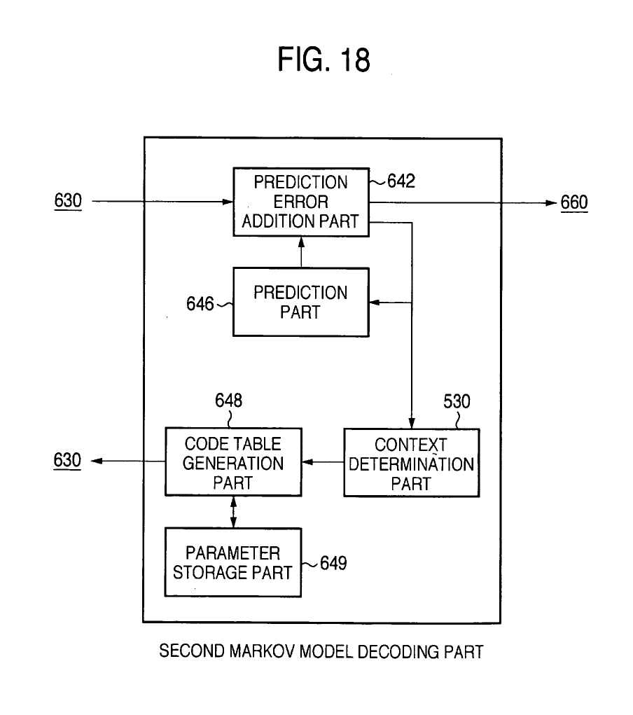

FIG. 18 is a view exemplifying a structure of a second Markov model decoding part. That is, a second decoding program 62 in the second embodiment has such a structure that in the first decoding program 6 shown in FIG. 10, the Markov model decoding part 640 is replaced by a second Markov model decoding part exemplified in FIG. 18. Incidentally, in respective components shown in this drawing, those substantially equal to the components shown in FIG. 10 are denoted by the same reference numerals.

In the second Markov model decoding part, a second code table generation part 648 (code table selection unit) refers to a parameter storage part 649, selects a code table (in this example, a decode parameter) corresponding to a context determined by the context determination part 530, and outputs the selected code table (decode parameter) to the entropy decoding part 630 (FIG. 10).

The parameter storage part 649 stores plural code tables made to correspond to contexts. The code table stored in the parameter storage part 649 causes code groups different from each other (for example, code groups corresponding to the same data and different in code length) to correspond to data values.

The parameter storage part 649 of this example stores plural decode parameters made to correspond to context values Q. These decode parameters are parameters used for decoding the Golomb codes.

A second prediction part 646 calculates the prediction value of the noticed pixel X based on the pixel values of the peripheral pixels A to D, and outputs the calculated prediction value to a prediction error addition part 642. That is, the second prediction part 646 outputs the prediction value calculated by using any one of the peripheral pixels A to D without correcting the prediction value directly to the prediction error addition part 642.

As described above, the coding program 52 of this embodiment uses the code parameter table 800 in which the code parameter corresponds to the context, and performs the Markov model coding, and accordingly, the natural image can be coded at high compression ratio and high speed.

Incidentally, the coding program 52 codes the CG image at high speed and high compression ratio by the run-length coding system in the case where the CG image is inputted.

Similarly, the decoding program 62 in this embodiment can decode the natural image and the CG image at high speed.

### MODIFIED EXAMPLES

Next, modified examples of the embodiment will be described.

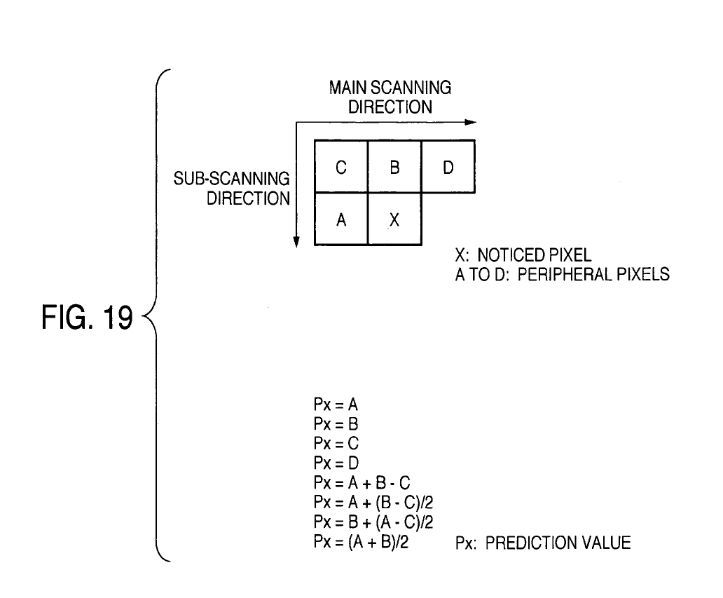

FIG. 19 is a view for explaining a modified example of a prediction process by the prediction part (that is, prediction parts 544, 548 or 646) of the Markov model coding part or the Markov model decoding part. Hereinafter, the modified example of the prediction part 544 will be described.

The prediction part 544 may calculate a prediction value Px of a noticed pixel X by expressions exemplified in FIG. 19. That is, the prediction part 544 may adopt the pixel value of any one of the peripheral pixels A to D directly as the prediction value Px, or may always adopt (A+B−C) as the prediction value Px irrespective of the magnitude relation of the peripheral pixels A to C. Besides, the prediction part 544 may calculate the prediction value Px of the noticed pixel X by any one of expressions indicated below.
Px=A+(B−C)/2
Px=B+(A−C)/2
Px=(A+B)/2

As stated above, the prediction part 544 of this modified example calculates the prediction value Px of the noticed pixel X without judging the magnitude relation of the peripheral pixels A to C, so that the calculation process of the prediction value can be speeded up.

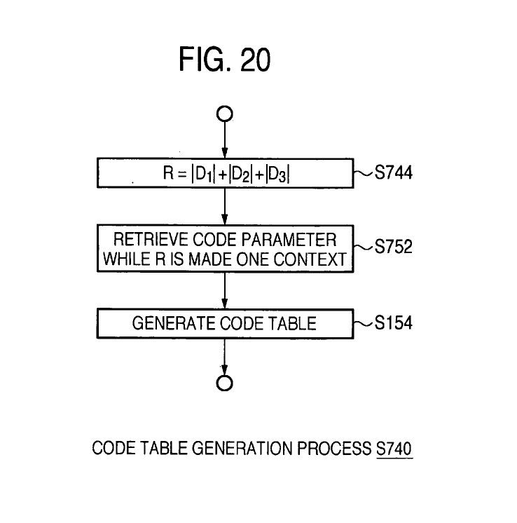

FIG. 20 is a flowchart of a modified example (S740) of a code parameter generation process. Incidentally, in respective processes shown in the drawing, those substantially equal to the processes shown in FIG. 17 are denoted by the same reference characters.

As exemplified in FIG. 20, in a third code table generation process (S740), the calculation process (S144 of FIG. 17) of a partial context value and the weighting process (S146 of FIG. 17) to the partial context value can be simplified.

That is, in this modified example, at step 744 (S744), the context determination part 530 adds the absolute value of the calculated difference value D₁, the absolute value of the calculated difference value D₂, and the absolute value of the calculated difference value D₃, and calculates the context value R in the modified example.

At step 746 (S746), the code table generation part 562 reads the code parameter corresponding to the context value R calculated by the context determination part 530 from the parameter storage part 590.

Incidentally, the parameter storage part 590 of this modified example may store plural code parameters made to correspond to the context values R, or may store plural code parameters made to correspond to numerical ranges of the context values R. In the case where the code parameter is made to correspond to the numerical range of the context value R, the code table generation part 562 judges which numerical range the calculated context value R belongs to, and reads the code parameter corresponding to the numerical range to which the context value R belongs.

At step 154 (S154), the code table generation part 562 outputs the read code parameter as the code table to the entropy coding part 570.

As stated above, the Markov model coding part of this modified example can simplify the calculation process (S144 of FIG. 17) of the partial context value and the weighting process (S146 of FIG. 17) on the partial context value.

Especially, in the example shown in FIG. 17, it is judged which of nine numerical sections the difference value D₁, the difference value D₂ and the difference value D₃ belong to. In the judgment process as stated above, it is necessary to compare the boundary values (threshold) of the respective numerical sections and the difference values, and it is necessary to perform the judgment process with respect to each of the three difference values.

However, in this modified example, since it is not necessary to judge the difference values as stated above, the process load can be suppressed.

[Hardware]

Next, a hardware structure of the image processing apparatus 2 in the embodiment will be described.

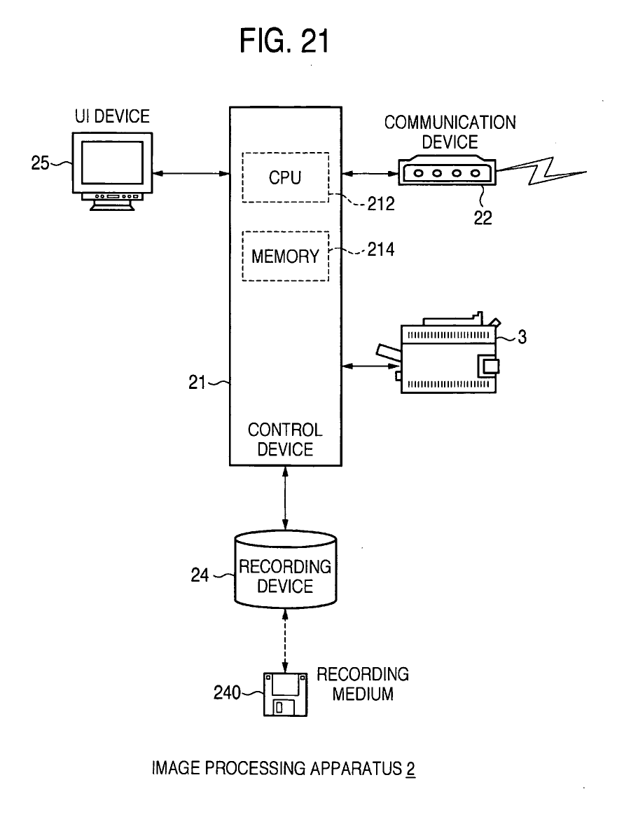

FIG. 21 is a view exemplifying the hardware structure of the image processing apparatus 2 (coding device, decoding device) to which the coding method and the decoding method of the invention are applied, while importance is attached to the control device 21.

As exemplified in FIG. 21, the image processing apparatus 2 includes the control device 21 including a CPU 212, a memory 214 and the like, a communication device 22, a recording device 24 such as a HDD or CD device, and a user interface device (UI device) 25 including an LCD display device or a CRT display device, a keyboard, a touch panel and the like.

The image processing apparatus 2 is a general-purpose computer in which the coding program (the first coding program 5 or the second coding program 52) of the invention and the decoding program (the first decoding program 6 or the second decoding program 62) are installed as part of the printer driver, acquires image data through the communication device 22 or the recording device 24, codes or decodes the acquired image data and transmits it to the printer device 3.

As described above, some embodiments of the invention are outlines below.

According to an aspect of the invention, a coding device includes a first coding unit that uses a Markov model coding system to code noticed data as a coding object, a second coding unit that uses a coding system different from the Markov model coding system to code the noticed data, and a selection unit that selects, as a coding unit to be applied, one of the first coding unit and the second coding unit based on the noticed data.

In the coding device, the second coding unit may use a run-length coding system to code the noticed data.

In the coding device, the second coding unit may code consistent information indicating a consistent degree of the noticed data and other reference data, and the selection unit may compare the noticed data with the reference data and may select the coding unit to be applied according to a comparison result.

In the coding device, the selection unit may compare the noticed data with reference data located at a fixed position with respect to the noticed data, and may select the first coding unit in a case where the noticed data is not consistent with any of the reference data.

In the coding device, the selection unit may compare the noticed data with at least one of the reference data, and may select the second coding unit in a case where the noticed data is consistent with any one of the reference data, and the second coding unit may code a continuous consistent number which indicates the number of the noticed data and the reference data continuously consistent with each other.

In the coding device, the first coding unit may include a context judgment unit that judges a context on the noticed data, a code group selection unit that uses a correspondence table to cause contexts to uniquely correspond to code groups and selects a code group corresponding to the context judged by the context judgment unit, and a code generation unit that uses the code group selected by the code group selection unit to generate a code of the noticed data.

In the coding device, the context judgment unit may judge the context of the noticed data only in a case where the first coding unit is selected by the selection unit.

The coding device may further include an identification information addition unit to add identification information to identify the coding unit selected by the selection unit to the code of the noticed data.

According to another aspect of the invention, a decoding device includes a first decoding unit that uses a Markov model coding system to code a noticed code as a decoding object, a second decoding unit that uses a coding system different from the Markov model coding system to decode the noticed code, and a decode selection unit that selects, as a decoding unit to be applied, one of the first decoding unit and the second decoding unit based on code identification information added to the noticed code.

In the decoding device, the first decoding unit may include a context judgment unit that judges a context of the noticed code based on other decoded data, a code table selection unit that uses a correspondence table to cause contexts to uniquely correspond to code groups and selects a code table corresponding to the context judged by the context judgment unit, and a decoded data generation unit that uses the code table selected by the code table selection unit to generate decoded data of the noticed code.

Besides, according to another aspect of the invention, a coding method includes selecting one of a Markov model coding system and another coding system based on noticed data as a coding object, and coding the noticed data by using the selected coding system.

Besides, according to another aspect of the invention, a coding method includes comparing noticed data as a coding object with reference data located at a fixed position with respect to the noticed data to select one of a Markov model coding system and a run-length coding system, and coding the noticed data by using the selected coding system.

Besides, according to another aspect of the invention, a decoding method includes selecting one of a Markov model coding system and another coding system based on code identification information added to a noticed code as a decoding object, and decoding the noticed code by using the selected coding system.

Besides, according to another aspect of the invention, a storage medium readable by a computer stores a program of instructions executable by the computer to perform a function, and the function includes selecting one of a Markov model coding system and another coding system based on noticed data as a coding object, and coding the noticed data by using the selected coding system.

Besides, according to another aspect of the invention, a storage medium readable by a computer stores a program of instructions executable by the computer to perform a function, and the function includes selecting one of a Markov model coding system and another coding system based on code identification information added to a noticed code as a decoding object, and decoding the noticed code by using the selected coding system.

According to an aspect of the invention, the coding device can realize a coding process at a relatively low process load.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A coding device comprising:
a first coding unit that uses a Markov model coding system to code noticed data as a coding object;
a second coding unit that uses a coding system different from the Markov model coding system to code the noticed data; and
a selection unit that selects, as a coding unit to be applied, one of the first coding unit and the second coding unit based on the noticed data.

2. The coding device according to claim 1, wherein the second coding unit uses a run-length coding system to code the noticed data.

3. The coding device according to claim 1, wherein
the second coding unit codes consistent information indicating a consistent degree of the noticed data and other reference data, and
the selection unit compares the noticed data with the reference data and selects the coding unit to be applied according to the comparison result.

4. The coding device according to claim 1, wherein the selection unit compares the noticed data with reference data located at fixed positions with respect to the noticed data, and selects the first coding unit in a case where the noticed data is not consistent with any one of the reference data.

5. The coding device according to claim 4, wherein
the selection unit compares the noticed data with at least one of the reference data, and selects the second coding unit in a case where the noticed data is consistent with any one of the reference data, and
the second coding unit codes a continuous consistent number which indicates the number of the noticed data and the reference data continuously consistent with each other.

6. The coding device according to claim 1, wherein the first coding unit includes:
a context judgment unit that judges a context on the noticed data;
a code group selection unit that uses a correspondence table to cause contexts to uniquely correspond to code groups and selects a code group corresponding to the context judged by the context judgment unit; and
a code generation unit that uses the code group selected by the code group selection unit to generate a code of the noticed data.

7. The coding device according to claim 6, wherein the context judgment unit judges the context of the noticed data only in a case where the first coding unit is selected by the selection unit.

8. The coding device according to claim 1, further comprising an identification information addition unit to add code identification information to identify the coding unit selected by the selection unit to the code of the noticed data.

9. A decoding device comprising:
a first decoding unit that uses a Markov model coding system to code a noticed code as a decoding object;
a second decoding unit that uses a coding system different from the Markov model coding system to decode the noticed code; and
a decode selection unit that selects, as a decoding unit to be applied, one of the first decoding unit and the second decoding unit based on code identification information added to the noticed code.

10. The decoding device according to claim 9, wherein the first decoding unit includes:
a context judgment unit that judges a context of the noticed code based on other decoded data;
a code table selection unit that uses a correspondence table to cause contexts to uniquely correspond to code groups and selects a code table corresponding to the context judged by the context judgment unit; and
a decoded data generation unit that uses the code table selected by the code table selection unit to generate decoded data of the noticed code.

11. A coding method comprising:
selecting one of a Markov model coding system and another coding system based on noticed data as a coding object; and
coding the noticed data by using the selected coding system.

12. A coding method comprising:
comparing noticed data as a coding object with reference data located at a fixed position with respect to the noticed data to select one of a Markov model coding system and a run-length coding system; and
coding the noticed data by using the selected coding system.

13. A decoding method comprising:
selecting one of a Markov model coding system and another coding system based on code identification information added to a noticed code as a decoding object; and
decoding the noticed code by using the selected coding system.

14. A storage medium readable by a computer, the storage medium storing a program of instructions executable by the computer to perform a function, the function comprising:
selecting one of a Markov model coding system and another coding system based on noticed data as a coding object; and coding the noticed data by using the selected coding system.

15. A storage medium readable by a computer, the storage medium storing a program of instructions executable by the computer to perform a function, the function comprising:
selecting one of a Markov model coding system and another coding system based on code identification information added to a noticed code as a decoding object; and
decoding the noticed code by using the selected coding system.
